(19) United States
(12) Patent Application Publication
(10) Pub. No.: US 2020/0104497 A1
(43) Pub. Date: Apr. 2, 2020

(54) METHOD, SYSTEM, AND APPARATUS FOR SECURITY ASSURANCE, PROTECTION, MONITORING AND ANALYSIS OF INTEGRATED CIRCUITS AND ELECTRONIC SYSTEMS IN METHOD, SYSTEM, AND APPARATUS FOR SECURITY ASSURANCE, PROTECTION, MONITORING AND ANALYSIS OF INTEGRATED CIRCUITS AND ELECTRONIC SYSTEMS IN RELATION TO HARDWARE TROJANS

(71) Applicant: Amida Technology Solutions, Inc., District of Columbia, WA (US)

(72) Inventors: Alfred Larry Crouch, Cedar Park, TX (US); John David Akin, Plano, TX (US); Adam Wade Ley, Allen, TX (US)

(73) Assignee: Amida Technology Solutions, Inc.

(21) Appl. No.: 16/450,336

(22) Filed: Jun. 24, 2019

Related U.S. Application Data
(63) Continuation-in-part of application No. 16/145,891, filed on Sep. 28, 2018.

(51) Int. Cl. G06F 21/56; G06F 21/76

(52) U.S. Cl. CPC G06F 21/567; G06F 21/76; G06F 21/561

(57) ABSTRACT

A method and system for analysis of a facility may include providing an emulation host system, first generating a golden circuit model on the emulation host system, first inserting a first hardware trojan model, first emulating operation of the golden circuit model, and second emulating operation of the first hardware trojan model. A facility may include a trojan instrument facility having a trojan detection instrument comparing logic circuit output against a threshold for detecting hardware trojan activity, and outputting alert data, and in relation to opening one of a plurality of scannable access points, a scannable register is inserted into an active scan chain with an associated instrument interface.

### CROSS-REFERENCE TO RELATED APPLICATIONS

This application is a continuation-in-part of U.S. Non-provisional patent application Ser. No. 16/145,891, filed 28 Sep. 2018 entitled Method, System, And Apparatus For Security Assurance, Protection, Monitoring And Analysis Of Integrated Circuits And Electronic Systems In Relation To Hardware Trojans (“Parent Application”).

This application claims priority to the Parent Application and hereby claims benefit of the filing date thereof pursuant to 37 C.F.R. § 1.78(a)(4).

The subject matter of the Parent Application is expressly incorporated herein by reference.

### FIELD OF THE INVENTION

The disclosure relates generally to methods, systems, and apparatus for security assurance, protection, monitoring and analysis of integrated circuits and electronic systems in relation to hardware trojans. Moreover, this disclosure relates to the use of instruments within integrated circuits and electronic systems for the purpose of detecting anomalous behaviors that may source from nefarious actions. More specifically, this disclosure relates to integrated circuits and/or electronic systems that may contain inherent malicious content known as Trojans, comprised of trigger and payload, where one or more portion of the Trojan may use an analog, parametric or environmental effect. These Trojans may be placed within integrated circuits by nefarious actions conducted by the supply chain elements of design and creation of the integrated circuit; or these Trojans may be inserted intentionally by white hat individuals emulating the electronic system within programmable devices as a method to investigate the activation, detection, operational impact, consequences and countermeasures associated with the inclusion and use of the Trojan through the use of data collection using embedded instruments.

### BACKGROUND OF THE INVENTION

In general, in the descriptions that follow, the first occurrence of each special term of art that should be familiar to those skilled in the art of integrated circuits (“ICs”) and systems will be italicized. In addition, when a term that may be new or that may be used in a context that may be new, that term will be set forth in bold and at least one appropriate definition for that term will be provided. In addition, throughout this description, the terms assert and negate may be used when referring to the rendering of a signal, signal flag, status bit, or similar apparatus into its logically true or logically false state, respectively, and the term toggle to indicate the logical inversion of a signal from one logical state to the other. Alternatively, the mutually exclusive Boolean states may be referred to as logic_0 and logic_1. Of course, as is well known, consistent system operation can be obtained by reversing the logic sense of all such signals, such that signals described herein as logically true become logically false and vice versa. Furthermore, it is of no relevance in such systems which specific voltage levels are selected to represent each of the logic states.

Hereinafter, reference to a facility shall mean a circuit or an associated set of circuits adapted to perform a particular function regardless of the physical layout of an embodiment thereof. Thus, the electronic elements comprising a given facility may be instantiated in the form of a hard macro adapted to be placed as a physically contiguous module, or in the form of a soft macro the elements of which may be distributed in any appropriate way that meets speed path requirements. In general, electronic systems comprise many different types of facilities, each adapted to perform specific functions in accordance with the intended capabilities of each system. Depending on the intended system application, the several facilities comprising the hardware platform may be integrated onto a single IC, or distributed across multiple ICs. Depending on cost and other known considerations, the electronic components, including the facility-instantiating IC(s), may be embodied in one or more single- or multi-chip packages. However, unless expressly stated to the contrary, the form of instantiation of any facility shall be considered as being purely a matter of design choice.

Electronic systems and facilities (hereinafter referenced, collectively, as “facility” or plural “facilities”) including circuits such as integrated circuits, chips, circuit boards, electronic devices, and components thereof, are subject to attacks and intrusions from malicious content or hardware trojans (hereinafter, collectively “hardware trojans”). As used herein, the term “hardware trojan” includes inherent malicious content or elements that may be included in a facility, and that may be exploited. For clarity, hardware trojans, as referenced herein, are to be distinguished from software trojans and related malicious software.

Hardware trojans, for example, may intend to function to break or prevent normal operation, allow unauthorized taking over or locking, steal data, steal circuit structure, degrade the hardware, degrade circuit operations, or inject errors into data being processed. A non-exhaustive listing of labels or references for hardware trojans includes, without limitation, the following: “denial of service” (DoS) indicating preventing the integrated circuit from conducting its normal function for some period of time; “ransomware” indicating the taking over or locking of an integrated circuit until a payment is extracted; “data theft” indicating that critical information stored or processed within the integrated circuit has been exfiltrated (such as, for example, customer information, account numbers and account passwords that can be used for identity theft and to access financial accounts); “structure theft” indicating that design or operation information concerning the electronic system or facility thereof has been exposed to enable reverse-engineering or counterfeiting; and “destructive operation” indicating that a facility or electronic system may be operated in such a manner as to provide physical damage (for example, operating built-in self-test logic (BIST) until a facility goes into thermal overload and physically melts).

The capability to allow these types of attacks stems from inadvertent or intentionally malicious content (i.e., “hardware trojans”) included within the facility hardware, such as integrated circuit hardware. Instantiations of malicious content, both inadvertent and intentional, may be labeled or referenced by several names, but may be generally referred to as “security vulnerabilities” or “security exploits” (hereinafter, collectively, “security exploits”). Security exploits may be incorporated within a facility, or within an electronic system including a facility, at any point in design, development, integration, implementation, testing, programming, packaging, and distribution; or at any point in the design-manufacturing-distribution supply chain.

Some hardware trojans may remain hidden or dormant while the facility or associated electronic system is in operation, until activated or triggered. Hardware trojans, when activated, may deliver or perform a previously hidden, intended purpose or action, which may be referenced as delivering its' “payload.”

Hardware trojans may be introduced into a facility, for example, when intellectual property (IP) cores (“IP cores”) are licensed from third parties for incorporation in an integrated circuit design. IP cores may include hidden trojan circuits providing various security exploits. So, for example, a design engineer acting with a nefarious purpose may include one or more trojan circuits to perform undesired functions, such as providing unsecured or readily enabled back-door access or memory space for future software viruses and malware. A design engineer also may design tools that generate, insert or synthesize circuit content, such as test and debug logic, that may be modified to include hardware trojans. A design engineer may design tools or provide implementations that operate on one form of design model to create a different, undesired form of design model. For example, logic synthesis from a behavioral model to a gate-level model may be mapped to the gate library that targets a specific fabrication facility. Also, for example, where design tools may provide a place-and-route conversion from a gate-level model to a physical model that adds and includes power, clock, electro-static-discharge (ESD) protection structures, the tools may be corrupted by being designed to add hidden malicious content during the conversions. In some scenarios, a circuit design may be passing through the fabrication process, for example in an IC foundry, and subtle changes in doping and chemical exposure may result in transistors, gates, signal routes and insulation layers not behaving properly in the final implemented silicon device. For example, the impacted elements may be sensitive to voltage levels or temperature levels or temperature ranges, or may produce unexpected emissions. Also, for example, during the IC testing process a programming step may place identification numbers or encryption codes or other defining steps for the integrated circuit device, and the test process may be altered to either provide incorrect values, or may place the values in alternate places within the device, where the misplaced values may be snooped or leaked in the future. Even when the sliced-and-diced silicon is packaged into plastic or ceramic chip carriers, devices may have unused signal connections or unused functions connected to package pins to be accessed by nefarious parties in the future. In an example, a package pin may be accessed and act as a signal connection to leak data, but may be misidentified in the IC data book as a ground connection.

Hardware trojans may be incorporated within custom designs such as, for example, application specific integrated circuits (ASICs), or may be incorporated within designs destined to become standard parts. Examples may include application specific standard parts (AS SPs), microprocessors, microcontrollers, systems-on-a-chip (SOCs), and standardized memory chips (DDR, DIMMS, HBM, etc.). When electronic systems are made from these chips, either custom systems made from custom IC's or systems made from commercial-off-the-shelf ICs (COTS), there is a risk that one or multiple chips incorporated into the electronic design may be compromised, or that groupings of chips can be arranged together to allow access to trojan malicious content at the system level or to create complex trojan malicious content at the system level. In an example, a hardware trojan may provide back door access to secured kernel memory that holds a primary operating system.

One goal of hardware trojan attacks may be to hide or obscure the hardware trojan, and the event or trigger (hereinafter “trigger”) used to activate the hardware trojan, from common forms of detection, such as during the verification, test and characterization process involved with the introduction of a new product; and the test, data-collection, evaluation, and yield-enhancement process involved with maintaining a yield target during manufacturing. To this end, some hardware trojans may be implemented with a scarcity of logic (such as just a doping change to silicon, or just an added transistor to a design that may include billions of transistors). Some hardware trojans may include extra routes hidden in plain sight, such as antenna loops added to the metal fill used to assist with chemical-mechanical-polishing (CMP). Hardware trojans and their triggers may be attached to a power domain that remains unpowered until activated by a rare event or contrived event that is known only by the nefarious party that intends to make use of the trojan hardware in the future. In some cases, even after a hardware trojan is activated and delivers its' payload, the payload action may be designed to resemble normal wear and tear, or faulty or defective behavior, of the targeted device or system, thus misleading the owner or user of the system to suspect a breakdown rather than a security attack. Some attacks, such as data exfiltration, may be meant to be invisible, so that the attack is not seen or detected by normal means. For example, radio-frequency (RF) emissions may be produced by trojan hardware from IC chips that do not possess known radio-frequency (RF) capability.

Modern Integrated Circuits (IC's) and electronic systems can be compromised by the inclusion of Trojans, e.g., stealthy, hidden or automated circuit content that can provide malicious access, control or destructive capability to the system or circuit under attack. Several instruments to detect digital Trojan trigger and payload activities were described in the Parent Application, the subject matter of which is expressly incorporated herein by reference. However, modern electronics may also be attacked in the analog or parametric realms as well. Analog features may generally be defined as signals or operations conducted by the electronic circuits that are not digital in nature, e.g., voltage or current waveforms, high-speed clocking signals, differential data signaling, and RF emissions (e.g., in a carrier wave—the transmitted data may be digital or analog, but the transport mechanism is analog). Parametric features generally refer to the parameters of the electronic operations such as the power supply voltage, the input-output drive voltage, and potentially the internal temperature generated by electronic circuit activity. Related to analog and parametric realms is also the environmental domain that may include ambient temperature, pressure, sound, vibration, humidity and other similar effects that surround the device or are an inherent quality of the electronic device under consideration.

Analog attacks may use analog or parametric signals to leak data/information, change the behavior of the circuit, or impact the reliability of the electronic device. By way of example, an analog waveform that uses voltage variations from 0.05 volts to 8.0 volts may describe a complex mathematical function that sources from a mechanical device and an Analog-to-Digital Convertor (“ADC”) may be used to sample and read the time-based voltage waveform to provide a digital numerical representation of the mechanical device's activity. The numbers generated by the ADC may be processed digitally using a microprocessor, and then new numbers generated by the microprocessor may be fed to a Digital-to-Analog Convertor (“DAC”) to provide feedback or control to the mechanical device using analog signals or waveforms. A Trojan can be applied to the digital portion of this loop, e.g., the digital data value stored in a register or processed by a microprocessor, the digital data used to drive the DAC, or the DAC itself. Similarly, the analog portion of the circuit may contain a Trojan that would alter either the captured waveform, the generated digital data from the analog waveform in the ADC, the drive/control waveform created by the DAC, or the analog signal or waveform during its propagation to or from the mechanical device.

One possible attack may be to directly leak out either the capture waveform or control waveform as direct analog voltage values. Another exemplary attack may be to alter the waveforms to create an instability in the capture-to-control loop. Yet another exemplary method of attack would be to amplify the analog signal modulation to cause the mechanical device to operate in a destructive manner. Several digital instruments were described in the Parent Application that allowed the anomalous behavior generated by digital Trojans to be detected, identified and even located within the electronic system.

It should be noted that analog and parametric circuits are difficult to simulate in a computing environment and are generally much larger in a physical sense than digital circuits. For the purpose of evaluation, many side-channel effects are only reasonably investigated when evaluated in hardware. By way of example, a digital simulation may show a digital register changing data on each rising-edge of an identified clock, but what is not identified by the digital simulation is that the data sequence applied generates a physical hot-spot that can be viewed with an infrared camera as a method for a malicious circuit to exfiltrate data. Similarly, specific data sequences applied generates a switching condition that causes a specific droop on the power supply lines that can also be used to exfiltrate data if a bad actor is viewing the power supplies reaction to providing power by monitoring the line voltage with an oscilloscope.

For reasons stated above and for other reasons which will become apparent to those skilled in the art upon reading and understanding the present specification, there is a need in the art for improved methods, systems, and apparatus for security assurance, protection, monitoring and analysis of facilities and electronic systems including circuits, such as integrated circuits, in relation to hardware trojans.

### BRIEF DESCRIPTION OF THE INVENTION

The above-mentioned shortcomings, disadvantages and problems are addressed herein, as will be understood by those skilled in the art upon reading and studying the following specification. This summary is provided to introduce a selection of concepts in simplified form that are further described below in more detail in the Detailed Description. This summary is not intended to identify key or essential features of the claimed subject matter.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The present disclosure provides methods, systems and apparatus for assurance, protection, analysis and monitoring of facilities, and electronic devices including facilities, that may provide improved detection, identification, functional and structural characterization, correction, curing and/or compensation for the presence and/or functions of hardware trojans, including associated trojan triggers and trojan payloads (hardware trojans, trojan triggers and trojan payloads being referenced, collectively, as “hardware trojans”). The present disclosure provides methods, systems and apparatus for improved assurance, protection, analysis and monitoring of facilities, and electronic devices including facilities, that do, or may, include one or more hardware trojans, which reduce or avoid complexity, difficulty and uncertainty that may be encountered when such a facility includes undetected, unpredicted or uncharacterized hardware trojans when designed, manufactured, tested, or placed into service. Embodiments according to this disclosure may recognize, avoid and/or reduce problems that may be encountered in providing and assuring operation of facilities, and electronic devices including same, where the subject integrated circuit may be placed into operation after a hardware trojan is activated by a trojan trigger or has delivered the trojan payload without detection, cure or compensation for the trojan. Embodiments according to this disclosure may recognize, avoid and/or reduce problems that may be encountered in providing and assuring operation of facilities, where subject facilities or silicon devices are, or may be, compromised and thus include, or may include, one or more hardware trojans, and the subject facility is available for integration and is to be placed into operation within the electronic system, wherein detection of the hardware trojan before it is activated and delivers its payload (such as, for example only, denial-of-service, take-over for ransomware, destructive operation, exfiltration of critical data, or degraded system performance) otherwise is significantly more difficult or improbable, and compensation or curing of the hardware trojans and nefarious functions of the hardware trojans also is significantly more difficult, or improbable. According to the present disclosure, methods, systems and apparatus may address, resolve or reduce impairments of operating facilities having one or more problems associated with, caused or impeded by the difficulty of detecting hardware trojans when the trojan is activated and/or the trojan payload is delivered. As further described below, these and other problems may be resolved in accordance with embodiments of this disclosure.

One problem is that operating a facility, IC or electronic system in all of the potential configurations to create a “trigger event” is not easily possible. Some “rare event” operations may not be anticipated by the facility, IC or system development originators.

Another problem is that operating a facility, IC or electronic system to the edge of “destruction” in order to activate a hardware trojan presents risk to the facility, IC or electronic system, and is not an activity generally consistent with existing, identified best practices for developers or users of systems. Operating a facility, IC or electronic system where a hardware trojan is actually active may result in destruction of the facility, IC or electronic system. Discovering that the hardware trojan is destructive may not be an acceptable outcome. For example, discovering that a hardware trojan resides in a fuel metering device, and activates within an aircraft only above 30,000 feet when certain high G-force load maneuvers are performed, such that the hardware trojan causes the fuel delivery to shut down completely, may be an unacceptable outcome.

One problem is that placing the facility or IC in a test or debug mode may activate an anti-trigger that ensures that the power driver for the hardware trojan and trigger logic is disabled. For example, when the manufacturing test scan-enable (SE) signal is transitioned to activate the capability to use scan chains to dump the state of the registers within the integrated circuit chip, the registers involved with the hardware trojan are excluded from the scan chains, and the power domain that includes those registers is disabled.

Another problem is that facilities, IC's, and electronic systems are tested and characterized economically in that they only possess test vectors and characterization vectors, and operating code when applied to the facility or IC represents only proving the specification of the intended design. If malicious content is contained within a facility, IC or electronic system, such as within an intellectual property core (IP core) that contains features which exceed the need of the overall system (a common practice particularly where schedule determines delivery of a device), the excess features are not tested or characterized as part of the final design. Hardware trojans may be located within these hidden features, ports, signals, memories, etc., so that malicious content or back doors may be hidden. Capability or vectors do not exist in the final device for ordinary users to exercise this content, whereas a black hat attacker will have the necessary vectors and know the method to access the extra, hidden malicious content.

It is a problem that anomalous behaviors in a facility, IC or electronic system may result from actual defects, implementation errors, environmental sensitivities or conditions, design flaws, or specification bugs. Not all hardware trojan payloads can be instantly recognized as security attacks. Some hardware trojans may provide evidence as subtle as higher than normal power consumption, higher than normal operating temperature, noisy data transmissions, and other indicators that may fall within the normal operating range or represent operation outliers for defective devices. Debug and diagnosis of the device may take months in some cases and in some instances may result in final assessment of “no trouble found” or “cannot repeat”. In some cases, devices may be assumed to be defective and discarded until the population of supposedly defective devices becomes large enough to attract attention for evaluation. Some hardware trojans may be intended to exactly cause early life-cycle fails, and thus reduce the reliability and reputation of electronic devices that were previously considered highly reliable.

It is a problem that operating a facility, IC or electronic system within a digital simulator is slow and may present an untenable time problem. For example, storing information in the cloud as part of simulating normal function might require weeks to simulate a normal interaction. Digital simulators may not be capable of accommodating parametric hardware trojans, analog hardware trojans, or trojan side-channel triggers. For example, where the trigger for a hardware trojan is a particular modulation of the system power supply to just above and just below the normal operating voltage, digital simulation of such a trigger may not be possible. Similarly, digital simulation may not be practical where a device includes a hardware trojan triggered by temperature conditions. In one example, a device may run hot in a normal operating mode, and when repeatedly cooled with a coolant spray, a thermal monitor may trigger a hardware trojan which provides an unplanned input code to the device. Similarly, digital simulation may not be practical where test logic is activated during operation to provide repeated di/dt droops, that broaden the clock pulses generated by an on-die phased-locked-loop (PLL), and the trigger is a frequency counter that can recognize the slow down activity. Digital simulation may not be practical where events are outside the detection and parameters of a digital simulator. Using a mixed-mode simulator also may require identifying and modeling all analog or parametric features, in addition to the digital features, and such a mixed-mode simulation may be further slowed to a degree that is impractical or unworkable.

In one aspect, methods and systems are provided through which security of a target facility, such as an integrated circuit, is analyzed by emulation, in an emulation host system, of a golden circuit model and first hardware trojan model. Such a system may include a library of hardware trojan model files and a library of trigger model files. The system may include a library of instrument model files and a library of countermeasure files. The system may include a physical effects model of physical effects which may camouflage a trigger. An instrumented golden model bit-file, instrumented trojan model bit-file, or both may be synthesized in an emulation synthesis module. The emulation host system may include a programmable emulation hardware component, which may include a programmable FPGA. An emulation operating module may manage emulation operation of the synthesized instrumented golden model bit-file, instrumented trojan model bit-file, or both. A data collection module may collect and record data of the emulation operation of the synthesized bit-files. A data analysis module may analyze collected data in relation to a library of collected data for other instances, to identify correlations for developing profile signatures of hardware trojans.

In one aspect, methods and systems are provided through which facilities, IC's and electronic systems may be designed, manufactured, tested and placed into service with improved assurance, protection, analysis and monitoring of operation of the facility, IC or electronic system analyzed by emulation, in an emulation host system, of a golden circuit model and first hardware trojan model. Such a system may include a library of hardware trojan model files and a library of trigger model files. The system may include a library of instrument model files and a library of countermeasure files.

If attacks can also source from the analog, parametric and environmental realms, generally referred to as side-channels, then analog, parametric and environmental instruments that can provide data to a data collection engine aligning with the same goals that are important to digital attacks, e.g., detection, identification, location, threat impact assessment, are also needed to make a comprehensive cybersecurity monitoring system.

One embodiment of a solution to the investigation of integrated circuits (ICs) and electronic systems that may be infected with analog, parametric and environmental Trojans is to implement a golden model of the IC or electronic system within a programmable device, that may emulate the device or system in hardware. After implementing a golden model, it would be appropriate to investigate the golden model for Trojans in a virtualized environment by emulating analog, parametric and environmental Trojans and using analog, parametric and environmental instruments that are specifically designed to capture certain data associated with targeted functions. The hardware emulation environment provides a more comprehensive and realistic environment that can be used to observe side-channel effects instead of just the digital responses available through simulation or static assessment tools.

Some malfeasant circuits, e.g., those circuits that may be considered to be Trojan payloads along with their associated activating triggers, may use analog, parametric, or environmental effects to implement and deliver their malicious purpose. The analog, parametric, or environmental effect may be used to leak data or other information; may be used to alter the behavior of the device; or, can be used to impact the reliability of the device. By way of example, temperature can be used by a circuit to generate a temperature varying hot spot that can be modulated with internal data to provide an exfiltration mechanism for that data. By way of a different example, temperature can be elevated by the malicious circuit to exceed the package or silicon limit so as to cause damage and degraded operation or complete destruction. By way of yet a different example, a temperature sensor may be set up to recognize a particular temperature excursion, e.g., a sequence of temperature changes, that would initiate the activation of a Trojan payload.

The monitoring of the normal functional circuit for any sign of these additional security exploits may be satisfied through the use of analog, parametric, and environmental monitoring circuits embedded within the device under consideration. Some of these monitoring circuits may include features such as:
1. monitoring the power supply voltage for a suspicious pattern of drooping or modulation that could be used to: (a) leak or exfiltrate data or information as a coded signal in convolution with the normal power supply signal; or (b) activate, e.g., trigger, a Trojan payload through the comparison to a known power input sequence or signature;
2. monitoring the signal voltage associated with a function to similarly look for a suspicious pattern of drooping or modulation that could be used to (a) leak data or information as a coded signal in convolution with the normal signal voltage; or (b) activate, e.g., trigger, a Trojan payload;
3. monitoring the ambient temperature, humidity level, air pressure, or other environmental variable(s) for rapid changes, specific changes, or rare conditions that would represent a trigger condition or the exfiltration of data, or the onset of destructive or unsound reliability conditions;
4. monitoring electromagnetic and radio-frequency or light and sound emissions, in a narrow band or in a broad spectrum, for incoming or outgoing signaling that could represent the exfiltration of data or the assertion event for a Trojan trigger activation; and
5. monitoring direct analog waveforms for any change in expected parameters, e.g., pulse-width, amplitude, repeating period, i.e., frequency, or noise-floor level, to see if any of the parameters change within short time periods, for measurable time periods, or to different values over time.

These types of instruments, when added to a device or circuit that also contains digital instruments, increases the probability of detecting anomalies that could be attributed to malicious device content.

There is a cost involved with the support of dedicated analog, parametric and environmental instruments and monitors since they are frequently larger than their digital counterparts in area footprint and in their power and heat impact. In some embodiments, the embedded instruments within a device can be implemented through the re-use of existing analog, parametric and environmental resources such as ADCs, DACs, digital signal processors (“DSP”), temperature diodes, capacitor and inductor based hygrometers, and accelerometers that may be used for pressure sensing, e.g., barometer, or altitude determination, e.g., altimeter. Many of these types of sensors and monitors exist in common electronics today, for example within a smart phone or an automobile.

Apparatus, systems, and methods of varying scope are described herein. These aspects are indicative of various non-limiting ways in which the disclosed subject matter may be utilized, all of which are intended to be within the scope of the disclosed subject matter. In addition to the aspects and advantages described in this summary, further aspects, features, and advantages will become apparent by reference to the associated drawings, detailed description, and claims.

### BRIEF DESCRIPTION OF THE DRAWINGS

The disclosed subject matter itself, as well as further objectives, and advantages thereof, will best be illustrated by reference to the following detailed description of embodiments of the device read in conjunction with the accompanying drawings, wherein:

FIG. 1 is a simplified block diagram of a system for analyzing security of a target facility, in an exemplary embodiment.

FIG. 2 is a simplified flow diagram of a method for analyzing security of a target facility, in an exemplary embodiment.

FIG. 3 is a simplified flow diagram of a method for analyzing security of a target facility, in an exemplary embodiment.

FIG. 4 is a simplified flow diagram of a method for analyzing security of a target facility, in an exemplary embodiment.

FIG. 5 is a simplified flow diagram of a method for analyzing security of a target facility, in an exemplary embodiment.

FIG. 6 is a simplified flow diagram of a method for analyzing security of a target facility, in an exemplary embodiment.

FIG. 7 is a simplified flow diagram of a method for analyzing security of a target facility, in an exemplary embodiment.

FIG. 8 is a simplified flow diagram of a method for analyzing security of a target facility, in an exemplary embodiment.

FIG. 9 is a simplified flow diagram of a method for analyzing security of a target facility, in an exemplary embodiment.

FIG. 10 is a simplified block diagram of an emulation host system for analyzing security of a target facility, in an exemplary embodiment.

FIG. 11 is a simplified block diagram of an emulation host system isolated in a tamper-proof Faraday cage, in an exemplary embodiment.

FIG. 12 is a simplified block diagram of facility, showing details of a trojan instrument facility, in an embodiment.

FIG. 13 is a simplified block diagram of a facility, showing details of a countermeasure facility, in an embodiment.

FIG. 14 is a simplified block diagram of a facility, showing logic circuits monitored and protected by trojan instrument facilities and countermeasure facilities.

FIG. 15 is a simplified flow diagram of a method for operating a facility including a trojan instrument facility and countermeasure facility, in an exemplary embodiment.

FIG. 16 is a simplified flow diagram of a method for operating a facility including a trojan instrument facility and countermeasure facility, in an exemplary embodiment.

FIG. 17A is a simplified block diagram of a facility including an unconfigured programmable fabric, in an embodiment.

FIG. 17B is a simplified block diagram of the facility shown generally in FIG. 17A, with the programmable fabric including a secured trojan instrument facility.

FIG. 17C is a simplified block diagram of the facility shown generally in FIG. 17A, with the programmable fabric including a secured countermeasure facility.

FIG. 18 illustrates, in block diagram form, a messaging system used for analyzing the impact of digital Trojans, according to some embodiments;

FIG. 19 illustrates, in block diagram form, an exemplary general-purpose computing system adapted to instantiate any of the several embodiments;

FIG. 20 illustrates, in block diagram form, an analog chirp facility that may be adapted for use by the messaging system of FIG. 18;

FIG. 21 illustrates, in block diagram form, the messaging system of FIG. 18 with the chirp facility integrated into the send facility 1802 and the receive facility 1804

FIG. 22 illustrates, in waveform, the analog output of the chirp facility of FIG. 20 according to some embodiments;

FIG. 23 illustrates, in waveform, exemplary parameters of the analog output of the chirp facility of FIG. 20 according to some embodiments;

FIG. 24 illustrates, in block diagram form, an infected chirp facility according to some embodiments;

FIG. 25 illustrates, in waveform, the analog output of the chirp facility of FIG. 20 having been modified by the embedded trojan of FIG. 24 and observed at exfiltrate point of FIG. 24 using voltage amplitude modification, according to some embodiments;

FIG. 26 illustrates, in waveform, the analog output of the chirp facility of FIG. 20 having been modified by the embedded trojan of FIG. 24 and observed at exfiltrate point of FIG. 24 using pulse-width modification, according to some embodiments;

FIG. 27 illustrates, in waveform, the analog output of the chirp facility of FIG. 20 having been modified by the embedded trojan of FIG. 24 and observed at exfiltrate point of FIG. 24 using manipulation of time within the RPS noise-floor, according to some embodiments;

FIG. 28 illustrates, in waveform, the analog output of the chirp facility of FIG. 20 having been modified by the embedded trojan of FIG. 24 and observed at exfiltrate point of FIG. 24 using manipulation of the noise-floor level that can be used to exfiltrate data, according to some embodiments;

FIG. 29 is a simplified block diagram that shows the repeating periodic waveform being sampled for voltage level per a given time period.

FIG. 30 illustrates, in block diagram form, a hardware access facility adapted to capture and export the sample data generated by the hardware sampling function of FIG. 29;

FIG. 31 illustrates, in block diagram form, a hardware instrument adapted to evaluate an RPS according to some embodiments;

FIG. 32 illustrates, in block diagram form, a hardware trojan instrument facility adapted to evaluate an RPS according to some embodiments;

FIG. 33 illustrates, in block diagram form, a hardware trojan instrument facility adapted to evaluate an RPS according to some embodiments;

FIG. 34 illustrates, in waveform, an RPS signal sampling reduced to numerical representations indicating the segment index, an average voltage number for that segment, and the RPS index number, according to some embodiments;

FIG. 35 illustrates, in waveform, a simplified diagram of an exemplary operating temperature profile and a temperature excursion overlay according to some embodiments;

FIG. 36 illustrates a simplified waveform diagram that shows a simple temperature profile and a temperature excursion overlay and a method of sampling that allows an instrument to learn the waveform over time and to identify any anomalous excursions;

FIG. 37 is a simplified block diagram of a messaging system used for analyzing the impact of digital Trojans that includes a behavior modification denial-of-service Trojan and a temperature excursion trigger to activate the Trojan;

FIG. 38 is a simplified waveform diagram that shows a simple voltage power supply level profile or voltage signal profile and a voltage droop overlay;

FIG. 39 is a simplified waveform diagram that shows a simple voltage power supply level profile or voltage signal profile and a voltage droop overlay and a method of sampling that allows an instrument to learn the waveform over time and to identify any anomalous excursions; and

FIG. 40 is a simplified block diagram of a messaging system used for analyzing the impact of digital Trojans that includes a behavior modification denial-of-service Trojan and a voltage excursion trigger to activate the Trojan.

### DETAILED DESCRIPTION OF THE INVENTION

In this detailed description, reference is made to the accompanying drawings which form a part hereof, and in which is shown by way of illustration specific embodiments which may be practiced. These embodiments are described in sufficient detail to enable those skilled in the art to practice the embodiments and disclosure. It is to be understood that other embodiments may be utilized, and that logical, mechanical, electrical, and other changes may be made without departing from the scope of the embodiments and disclosure. In view of the foregoing, the following detailed description is not to be taken as limiting the scope of the embodiments or disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

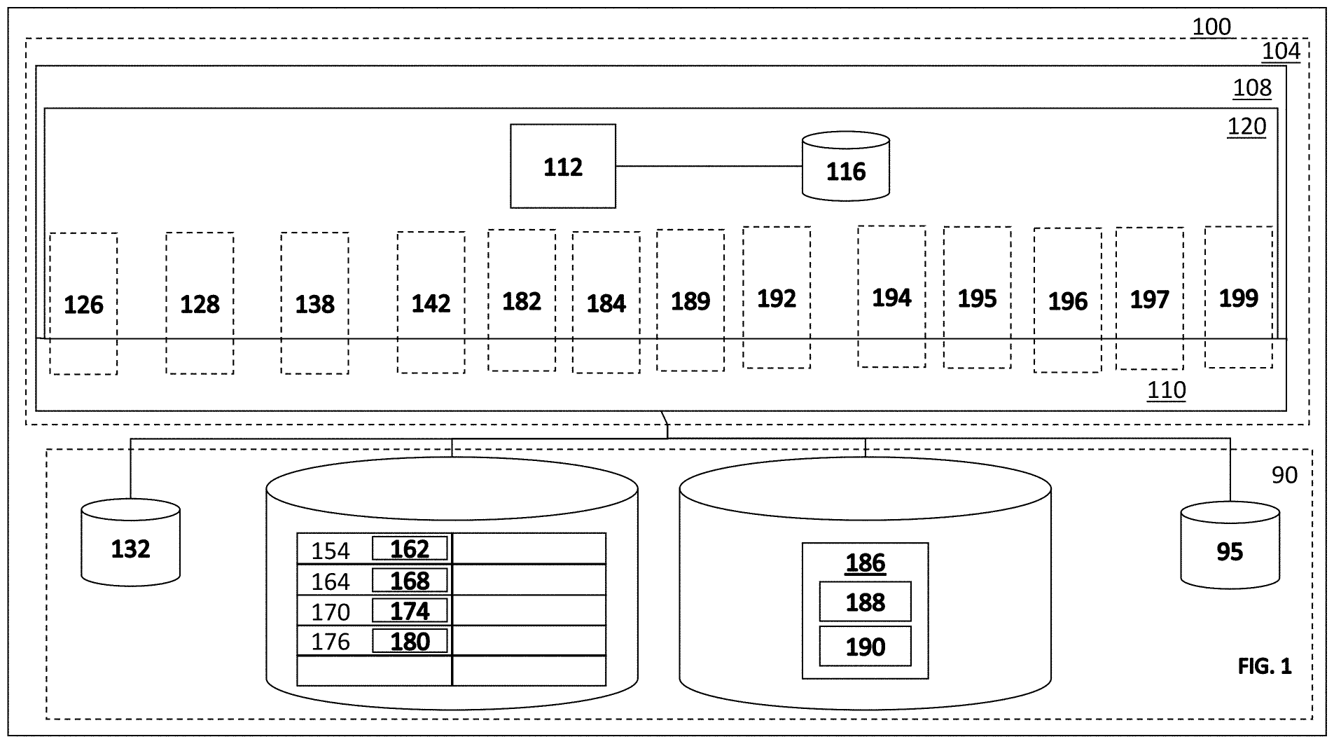

Illustrated in FIG. 1 is a simplified system diagram of a system 100 for analyzing security of a target facility (not shown), in an exemplary embodiment. System 100 includes an emulation host system 104. Emulation host system 104 may include a programmable hardware component 108 and programmable software component 110. Programmable hardware component 108 may include one or more processors 112 operably coupled to memory 116. In embodiments, programmable hardware component 108 may include a field programmable gate array (FPGA) 120. An FPGA of the Virtex® family made by Xilinx Inc., San Jose, Calif., is suitable. A suitable emulation host system 104 may be a Vivado® Simulator system available from Xilinx Inc., San Jose, Calif. A suitable emulation host system 104 may support mixed-language simulation and may include a hardware description compiler 126. Hardware description compiler 126 may include, for example, a compiler for an IEEE standard hardware description language (HDL) such as Verilog, SystemVerilog™, VHDL, or other hardware description language. In embodiments, emulation host system 104 may include one or more design conversion modules 128 configured to convert the high-level description to a logic-level register transfer level (RTL) description, a gate-level (GL) description, a layout-level description, or a mask-level description. A golden circuit model file 132 of the target facility (not shown) may be generated from a design library or other automated design technique. The golden circuit model file 132 may be synthesized from a design specification in a hardware description language (HDL), files or group of files, register transfer level (RTL) description, a gate-level (GL) description, a layout-level description, or a mask-level description, or from a netlist.

In embodiments, emulation host system 104 for emulation may include memory 116 which stores instructions, and one or more processors 112 coupled to the memory 116 to process instructions accessed in the memory 116. The one or more processors 112 may be configured to receive the golden circuit model file 132 for emulation. In some embodiments, the high-level design may be embodied in an IEEE standard hardware description language (HDL), Verilog, SystemVerilog™, VHDL, logic-level register transfer level (RTL) description, a gate-level (GL) description, a layout-level description, or a mask-level description. The golden circuit model file 132 design description may be compiled in a suitable hardware description language compiler.

Emulation host system 104 may include a clocked control and data flow graph (CCDFG) module 138 configured to provide control graphs for emulating operation of the golden circuit model. It will be understood that the CCDFG module 138 may identify or represent state-change or input-change bits. Emulation host system 104 may include an evaluating module 142 for producing emulation results from the CCDFG module.

System 100 for analyzing security of a target facility (not shown) may include a hardware trojan model file library 154. Hardware trojan model file library 154 may include a plurality of hardware trojan model files (“hardware trojan models”). Hardware trojan model file library 154 may include a first hardware trojan model file 162. The first hardware trojan model file 162 may be inserted into golden circuit model 132.

Referring to FIG. 1, in some embodiments, the first hardware trojan model file 162 may include all, or any, of the following: a first trojan payload model, a first trojan trigger model, a first trojan installation model, a first trojan content model, a first trojan operation model, and a first trojan behavior profile model. In some embodiments, a first trojan identification profile or signature profile may include all, or any, of the following: a first trojan payload model, a first trojan trigger model, a first trojan installation model, a first trojan content model, a first trojan operation model, a first trojan behavior profile model.

System 100 for analyzing security of a target facility (not shown) may include a trigger model file library 164. Trigger model file library 164 may include a plurality of trigger model files (“trigger models”). Trigger model file library 164 may include a first trigger model file 168. The first trigger model file 168 may be inserted into golden circuit model 132.

System 100 for analyzing security of a target facility (not shown) may include an instrument model file library 170. Instrument model file library 170 may include a plurality of instrument model files (“instrument models”). Instrument model file library 170 may include a first instrument model file 174. The first instrument model file 174 may be inserted into golden circuit model 132.

System 100 for analyzing security of a target facility (not shown) may include a countermeasure model file library 176. Countermeasure model file library 176 may include a plurality of countermeasure model files (“countermeasure models”). Countermeasure model file library 176 may include a first countermeasure model file 180. The countermeasure model file 180 may be inserted into golden circuit model 132.

System 100 for analyzing security of a target facility (not shown) may include a golden model file analysis module 192. Golden model file analysis module 192 may resolve analysis of the golden circuit model file 132.

System 100 for analyzing security of a target facility (not shown) may include an insertion process resolution module 182. Insertion process resolution module 182 may resolve insertion of the golden circuit model file 132 in relation to the emulation host system 104. Insertion process resolution module 182 may resolve insertion of the first hardware trojan model file 162, first trigger model file 168, first instrument model file 174 and file countermeasure model file 180 in relation to the golden circuit model file 132, emulation host system 104, or both.

System 100 for analyzing security of a target facility (not shown) may include an emulation synthesis resolution module 184. Emulation synthesis resolution module 184 may resolve synthesis of emulation bit-files 186. The emulation bit-files 186 may include an instrumented golden model bit-file 188, instrumented trojan model bit-file 190, or both.

System 100 for analyzing security of a target facility (not shown) may include an emulation hardware programming module 194. Emulation hardware programming module 194 may manage programming of the hardware component 108 to configure same to perform emulation operation in relation to the synthesized emulation bit-files 186, including the instrumented golden model bit-file 188, instrumented trojan model bit-file 190, or both.

System 100 for analyzing security of a target facility (not shown) may include an emulation hardware operation module 195. Emulation hardware operation module 195 may manage emulation operation of the emulation host system 104 to perform emulation operations in relation to the synthesized emulation bit-files 186, including the instrumented golden model bit-file 188, instrumented trojan model bit-file 190, or both.

System 100 for analyzing security of a target facility (not shown) may include an emulation data collection module 196. Emulation data collection module 196 may manage data collection from emulation operations of the synthesized emulation bit-files 186, including the instrumented golden model bit-file 188, instrumented trojan model bit-file 190, or both.

System 100 for analyzing security of a target facility (not shown) may include an emulation data analysis module 197. Emulation data analysis module 197 may manage analysis of data collected by data collection module 196 from emulation operations of the synthesized emulation bit-files 186, including the instrumented golden model bit-file 188, instrumented trojan model bit-file 190, or both.

In some embodiments, the emulation host system 104 may include an FPGA. In embodiments, the emulation host system may include an FPGA and circuit board in communication with said FPGA. In some embodiments, the emulation host system may include an access port 189 supporting JTAG protocol for communication with the FPGA.

In some embodiments, system 100 may include a Faraday cage (not shown in FIG. 1) configured to isolate the emulation host system 104 and all file libraries 90 from electromagnetic attack. In some embodiments, the plurality of file libraries 90 may include a library 95 of archived data collected in security analysis of a plurality of target facilities. System 100 may include an analysis module 199 including a machine learning sub-module, configured to determine correlations from the library 95 of archived data.

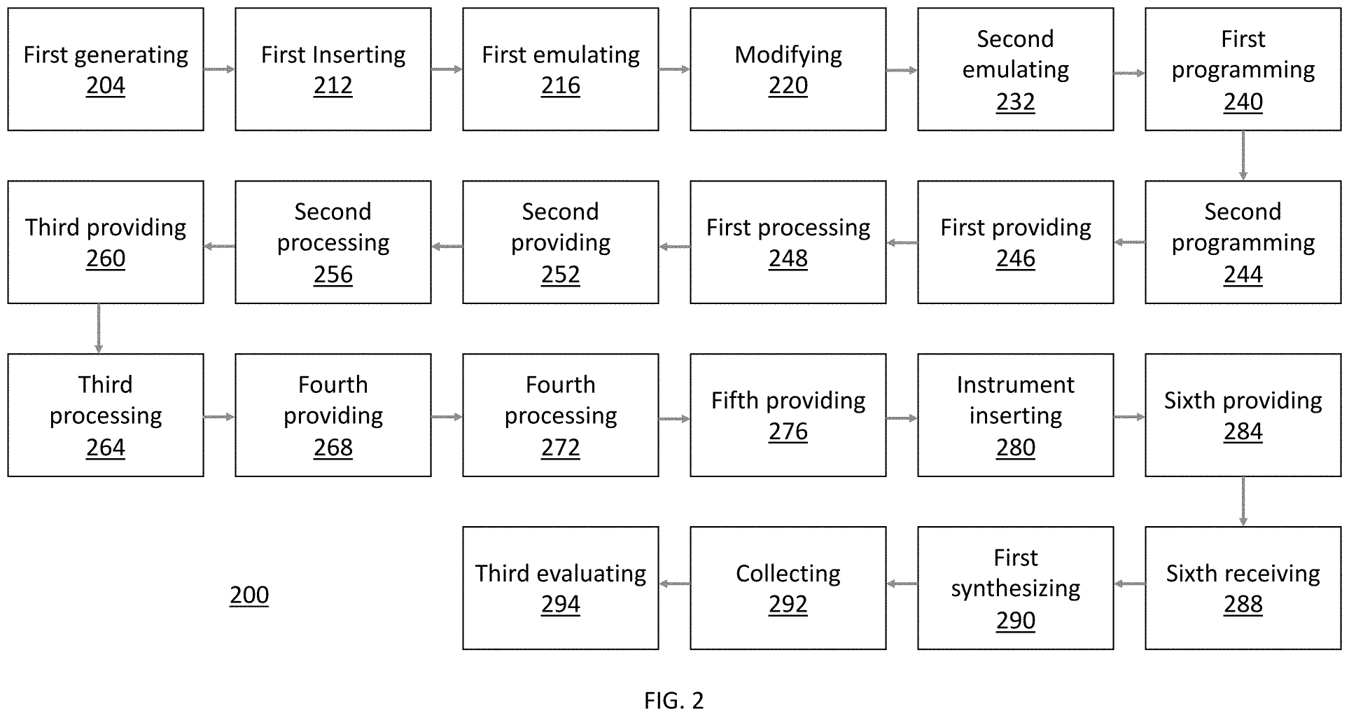

FIG. 2 is a simplified flow illustrating a method 200 for analyzing security of a target facility (not shown), in an exemplary embodiment. Method 200 may include: first generating 204 a golden circuit model on an emulation host system. The golden circuit model may be generated by synthesis from a detailed specification in a design library, other automated design technique, hardware description language (HDL), files or group of files, register transfer level (RTL) description, a gate-level (GL) description, a layout-level description, a mask-level description, or a netlist. In embodiments, the golden circuit model may be identical to golden circuit model 132 of system 100, or may differ as otherwise described herein.

Referring to FIG. 2, method 200 may include: second providing 208 a first hardware trojan model of a first hardware trojan. Method 200 may include: first inserting 212 the first hardware trojan model on the emulation host system. Except as otherwise described or illustrated, the first hardware trojan model may be identical to first hardware trojan model file 162 of system 100. Method 200 may include first emulating 216, by the emulation host system, operation of the golden circuit model. Method 200 may include modifying 220 the golden circuit model, upon the first inserting 216 of the first hardware trojan model, to provide a trojan-modified portion of the golden circuit model. Thus, in the first emulating 216, the golden circuit model may include the trojan-modified portion of the golden circuit model.

Method 200 may include second emulating 232 operation of the first hardware trojan model in relation to the first emulating. The second emulating 232 may be performed by operation the emulation host system.

Method 200 may include first programming 240 the programmable hardware component to configure the same to perform the first emulating 216. Method 200 may include second programming 244 the programmable application software component to configure the same to embody the first hardware trojan model. Second programming 244 may include configuring the programmable application software component to perform emulation operation, simulation operation, or both, in relation to the first hardware trojan model.

Method 200 may include first providing 246 an external physical effects model. Method 200 may include first processing 248 the external physical effects model, by the emulation host system. The external physical effects may provide a camouflaged first trojan trigger. The external physical effects model may include model effects selected from the group consisting of: parametric effects, analog effects, and side-channel effects.

Method 200 may include second providing 252 a first analog effects model of a first analog function affecting the target facility. Method 200 may include second processing 256 the first analog effects model, by the emulation host system.

Method 200 may include third providing 260 a first thermal effects model of a first thermal function affecting the target facility. Method 200 may include third processing 264 the first thermal effects model, by the emulation host system.

Method 200 may include fourth providing 268 a first fabrication effects model of first fabrication variables affecting the target facility. Method 200 may include fourth processing 272 the first fabrication effects model, by the emulation host system.

Method 200 may include fifth providing 276 a programmable circuit instrumentation fabric. Method 200 may include instrument inserting 280 into the golden circuit model, to provide an instrumented golden circuit model. In some embodiments, the above-referenced first inserting 212 of the first hardware trojan model may be embodied by providing the programmable circuit instrumentation fabric and programming the circuit instrumentation fabric to embody the first hardware trojan model.

Method 200 may include sixth providing 284 model instrumentation in relation to the golden circuit model. Method 200 may include sixth receiving 288, by the model instrumentation, data in relation to the golden circuit model.

Method 200 may include first synthesizing 290, by the emulation host system, an instrumented golden circuit model including instrumentation and a trojan-modified portion. Method 200 may include collecting 292 data of the first emulating. Method 200 may include third emulating 294, by the emulation host system, a countermeasure. Method 200 may include, in the first emulating, first configuring a programmable hardware component of the emulation host system with the golden circuit model.

In some embodiments of method 200, in the first emulating, the golden circuit model may be a synthesized golden circuit model including modifying content. The modifying content may include: programmable circuit instrumentation, programmable circuit instrumentation fabric, model instrumentation, and/or the first hardware trojan model.

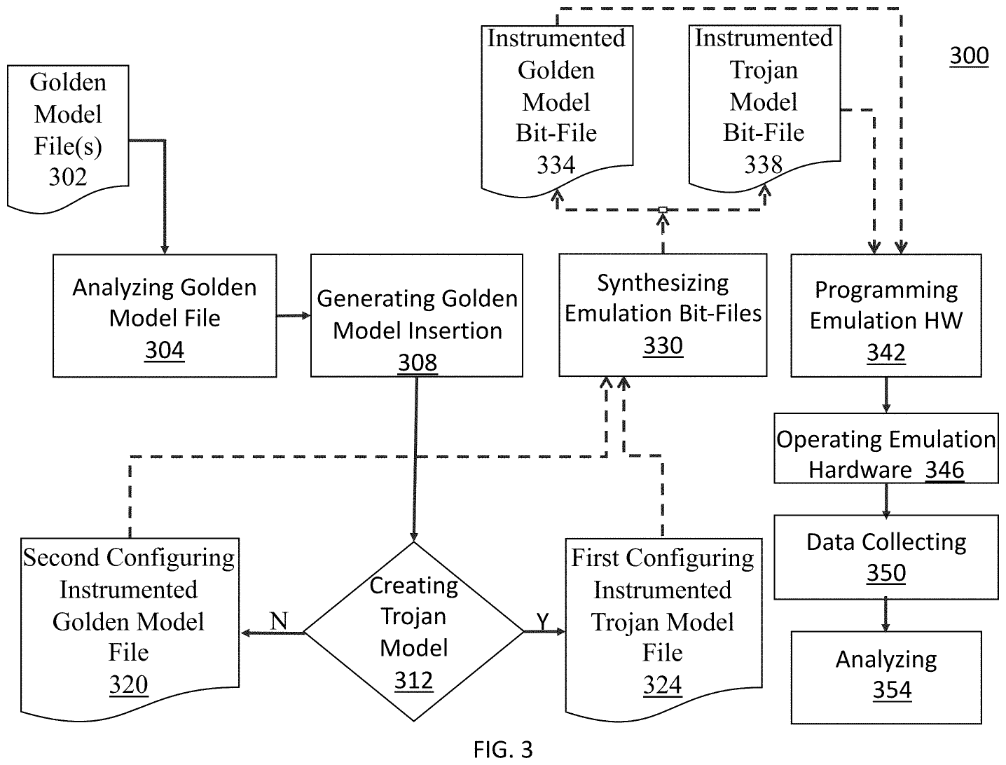

FIG. 3 is a simplified flow diagram of a method 300 for analyzing security of a target facility, by analyzing a golden circuit model in an emulator host system, in an exemplary embodiment. Method 300 may be identical to method 200 previously described herein, except as otherwise described or illustrated. Method 300 may include analyzing 304 a golden circuit model file 302. Method 300 may include generating a golden circuit model file 308. Method 300 may include creating 312 a first hardware trojan model. Method 300 may include first configuring 324 an instrumented first hardware trojan model. Method 300 may include second configuring 328 an instrumented golden circuit model. Method 300 may include synthesizing 330 emulation bit-files, which may include an instrumented golden circuit model bit-file 334 and instrumented hardware trojan model bit-file 338. Method 300 may include programming 342 an emulation hardware component of the emulation host system. Method 300 may include operating 346 the emulation hardware component to emulate operation of the golden circuit model, by operation of the instrumented golden circuit model bit-file 334 and instrumented hardware trojan model bit-file 338. Method 300 may include collecting 350 data for emulation operation of the instrumented golden circuit model bit-file 334 and instrumented hardware trojan model bit-file 338. Method 300 may include analyzing 354 collected data of emulation operation of the instrumented golden circuit model bit-file 334 and instrumented hardware trojan model bit-file 338.

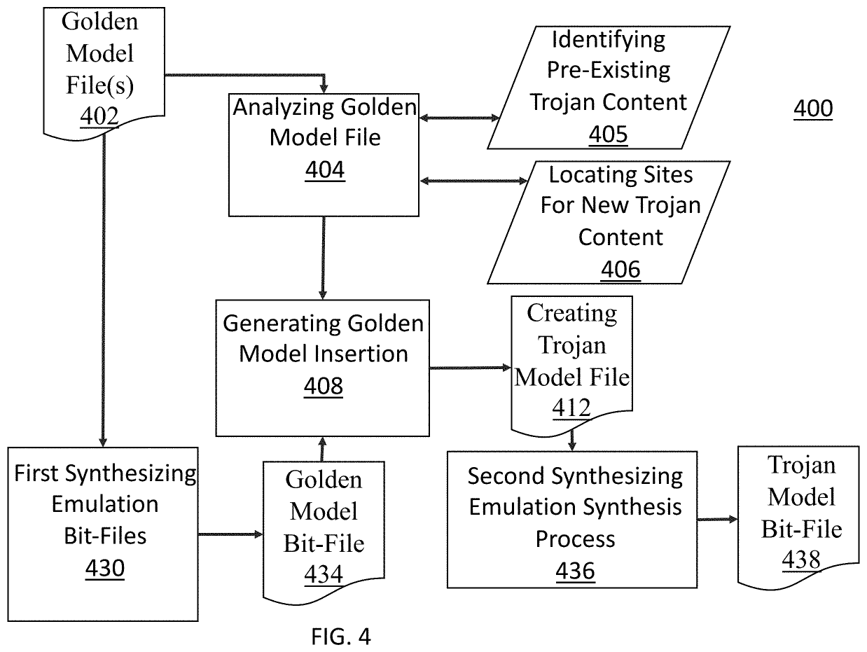

FIG. 4 is a simplified flow diagram of a method 400 for analyzing security of a target facility, by analyzing a golden circuit model in an emulator host system, in an exemplary embodiment. Method 400 may be identical to method 300 previously described herein, except as otherwise described or illustrated. Identifying 405 of pre-existing trojan content in the golden circuit model is performed in relation to analyzing 404 the golden circuit model. Locating 406 is performed to identify locations for new trojan content to be added.

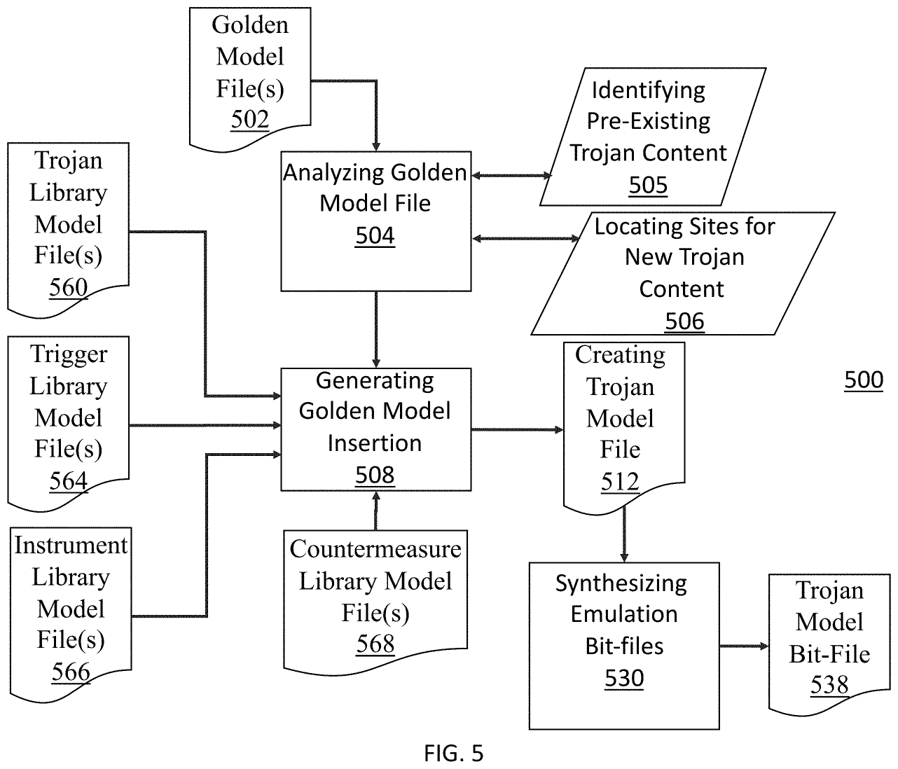

FIG. 5 is a simplified flow diagram of a method 500 for analyzing security of a target facility, by analyzing a golden circuit model in an emulator host system, in an exemplary embodiment. Method 500 may be identical to method 300 previously described herein, except as otherwise described or illustrated. Identifying 505 of pre-existing trojan content in the golden circuit model is performed in relation to analyzing 504 the golden circuit model 502. Locating 506 is performed to identify locations for new trojan content to be added. The emulation host system includes multiple libraries: hardware trojan model files library 560, trigger model files library 564, instrument model files library 566 and countermeasure model files library 568. When generated 508, the golden circuit model may include a selected model file of each library.

FIG. 6 is a simplified flow diagram of a method 600 for analyzing security of a target facility, by analyzing a golden circuit model in an emulator host system, in an exemplary embodiment. Method 600 may be identical to method 500 previously described herein, except as otherwise described or illustrated. Identifying 605 of pre-existing trojan content in the golden circuit model is performed in relation to analyzing 604 the golden circuit model 602. Locating 606 is performed to identify locations for new trojan content to be added in the golden circuit model 602. The emulation host system includes instrument model files library 666 and countermeasure model files library 668. When generated 608, an instrumented golden circuit model may be created 612.

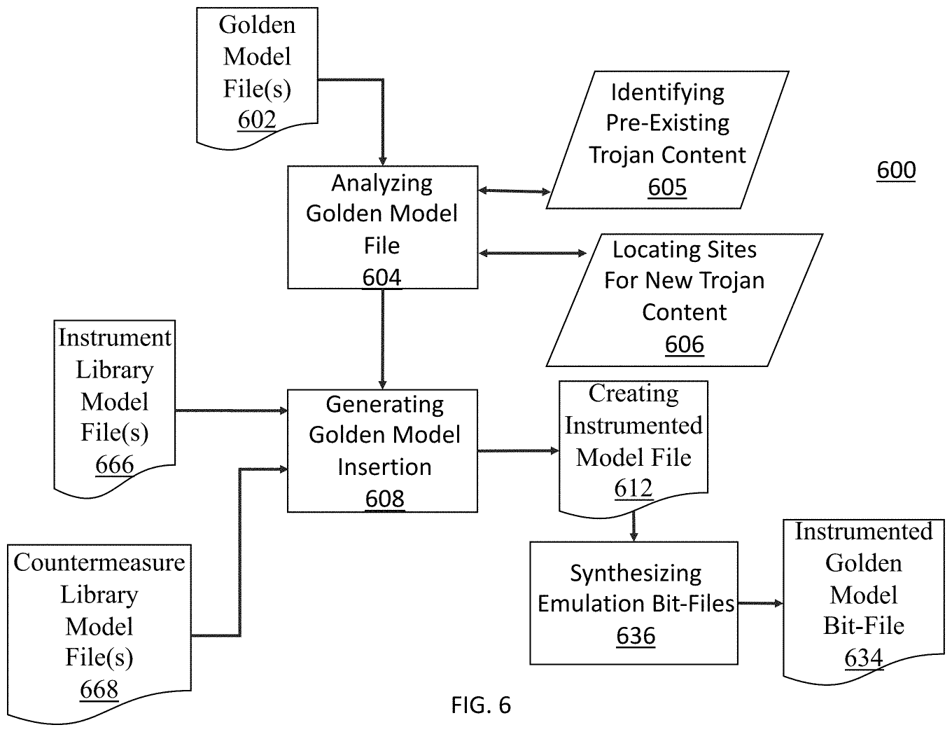

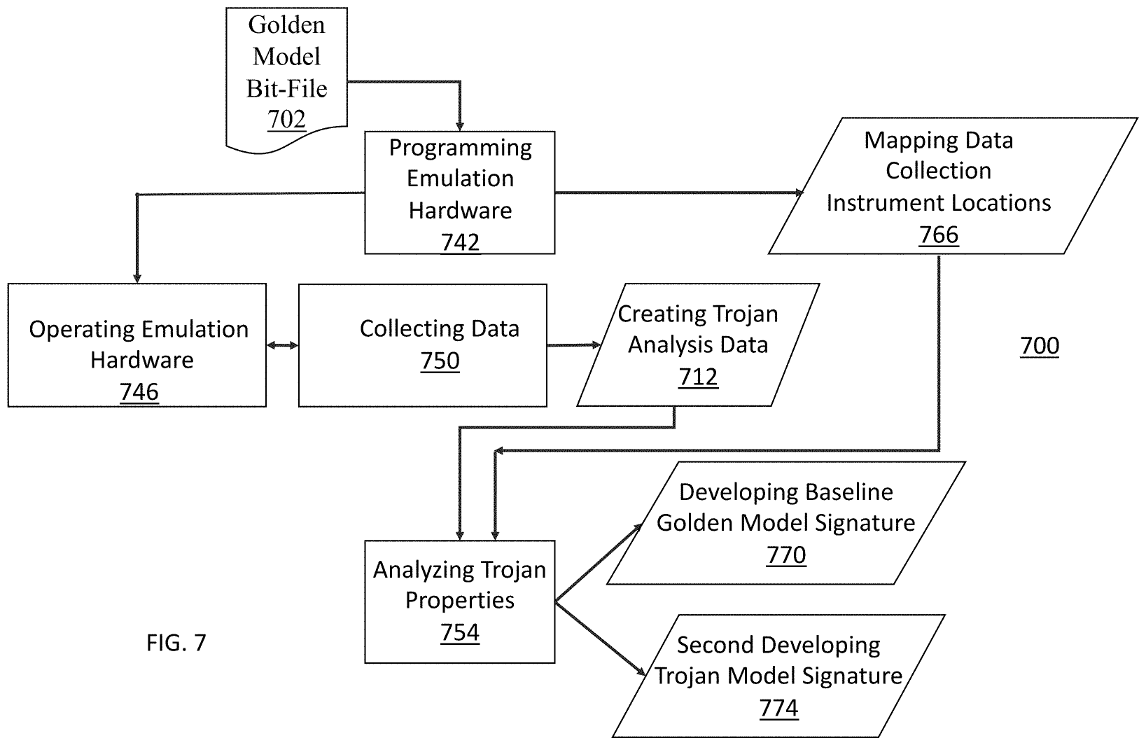

FIG. 7 is a simplified flow diagram of a method 700 for analyzing security of a target facility, by analyzing a golden circuit model in an emulator host system, in an exemplary embodiment. Method 700 may be identical to method 300 previously described herein, except as otherwise described or illustrated. Mapping 766 of instrument locations is performed in relation to the golden circuit model 702. Analyzing 754 of hardware trojan properties is performed. Method 700 includes the step of developing 770 a baseline golden model signature. Method 700 includes the step of second developing 774 a hardware trojan model signature.

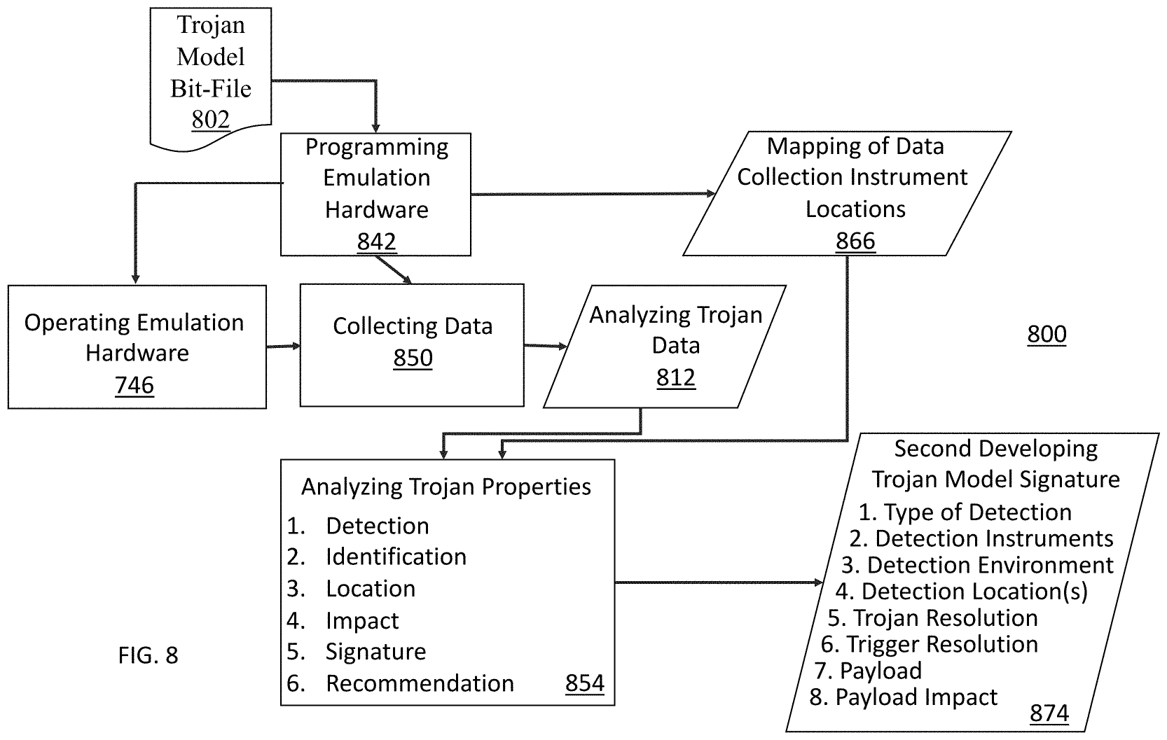

FIG. 8 is a simplified block diagram of a method 800 for analyzing security of a target facility, by analyzing a golden circuit model in an emulator host system, in an exemplary embodiment. Method 800 may be identical to method 700 previously described herein, except as otherwise described or illustrated. Analyzing 854 of hardware trojan properties is performed. Method 800 includes the step of developing 870 a baseline golden model signature. Method 800 includes the step of second developing 874 a hardware trojan model signature.

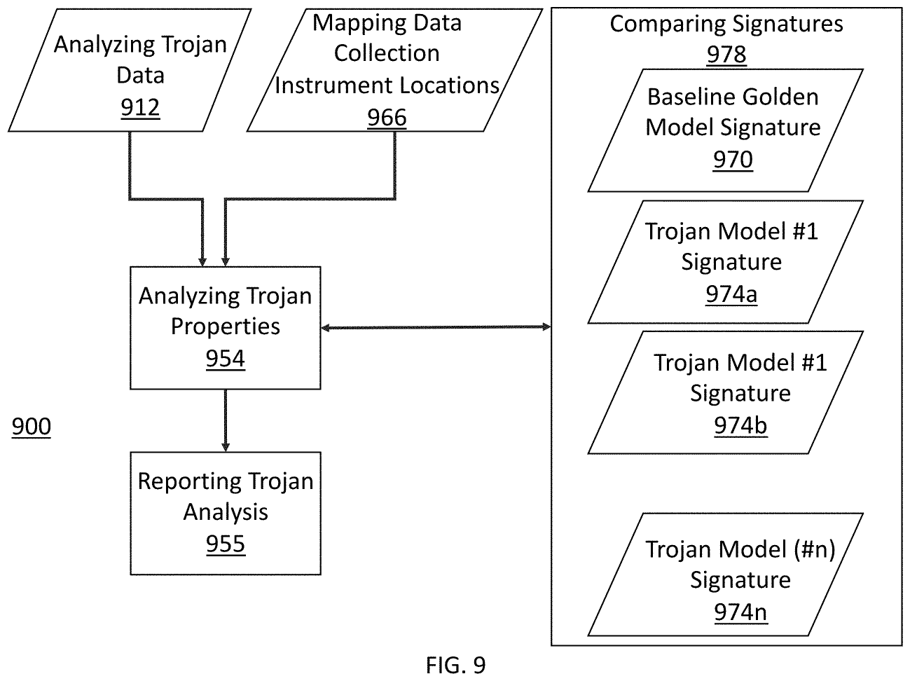

FIG. 9 is a simplified block diagram of a method 900 for analyzing security of a target facility, by analyzing a golden circuit model in an emulator host system, in an exemplary embodiment. Method 900 may be identical to method 800 previously described herein, except as otherwise described or illustrated. Method 900 includes comparing 978 signatures. Comparing 978 includes comparing signatures of a subject golden circuit model 970 with a database of pre-existing golden circuit model signatures. Comparing 978 includes comparing signatures of a subject trojan model 974a, 974b, 974n with a database of pre-existing golden circuit model signatures. Method 800 includes the step of second developing 874 a hardware trojan model signature.

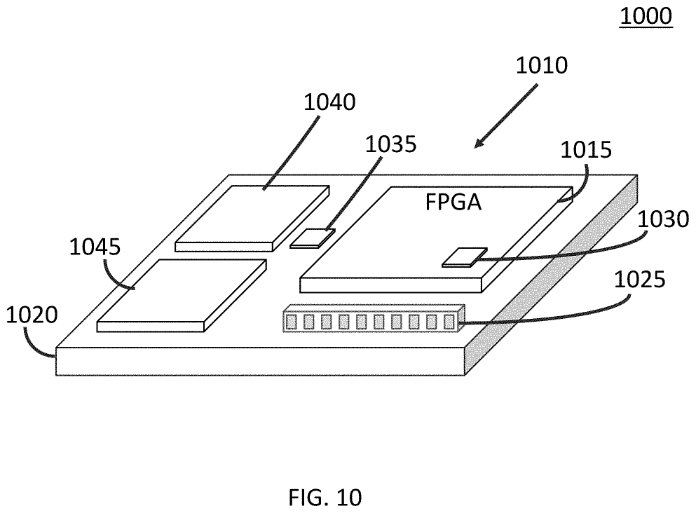

FIG. 10 is a simplified block diagram of a system 1000 for analyzing security of a target facility, by analyzing a golden circuit model in an emulator host system, in an exemplary embodiment. System 1000 may include an emulation host system 1010. Emulation host system 1010 may include a programmable hardware component 1015. Programmable hardware component 1015 may include an FPGA electrically coupled with a circuit board 1020. The FPGA is programmable to emulate a golden circuit model. In other embodiments (not shown), the programmable hardware component may include, for example, a system-on-chip (SOC) or ASIC. Circuit board 1020 may include an on-board connector 1025. First detection instruments 1030 may be configured within the programmable FPGA. Second detection instruments 1035 also may be located on the circuit board 1020 near FPGA 1015. The exemplary circuit board 1020 may be accessed or combined with other circuit boards (not shown) through one or more of the on-board connectors 1025. The circuit board 1020 may include many other supporting integrated circuits, both digital 1040 and analog 1045, to support the use and operation of the circuit board 1020 as a standalone device or ganged together with other circuit boards. The supporting circuits may include, for example, voltage conditioning ICs, signal repeater ICs, switches, buttons, LED displays, and other supporting circuits.

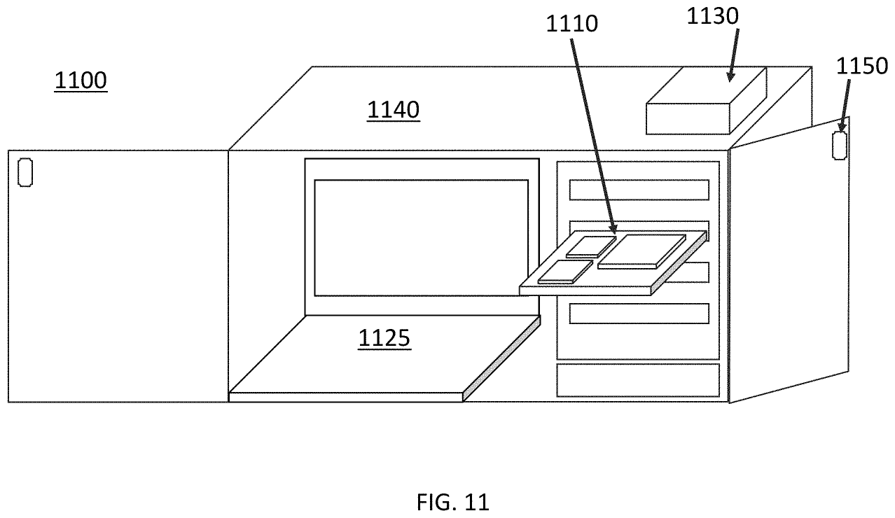

FIG. 11 is a simplified block diagram of a system 1100 for analyzing security of a target facility, by analyzing a golden circuit model in an emulator host system, in an exemplary embodiment. System 1100 may include an emulation host system 1110. Emulation host system 1110 may include a programmable hardware component, including an FPGA. The emulation host system 1110 may include multiple FPGA's ganged together, and in some embodiments such FPGA's may be supported on circuit boards mounted in multiple slots. Emulation host system 1110 may include a programmable software component. Programmable software component may include application software embodied in non-transient computer readable medium. Emulation host system 1110 may include a computer processing platform 1125 including a processor operably coupled with memory for execution of the application software. The computer processing platform 1125 may house and host the software involved with the evaluation process (programming the FPGAs, evaluation, insertion, the libraries, operation, instrument configuration, data collection, data analysis). System 1100 may include an insulated, opaque Faraday cage container 1140 configured to isolate and prevent electromagnetic attacks on the emulation host system 1110 and associated libraries. The libraries may include golden circuit model files library, hardware trojan model files library, trigger model file library, countermeasures model file library, golden model signature library, and trojan model signature library. System 1100 also may include a lock 1150 on Faraday cage container 1140 to physically secure the emulation host system 1110 and computer processing platform 1125, to prevent tampering and corrupting of the emulation host system 1110 and libraries. The lock 1150 may be configured to secure the case and complete the Faraday cage. In an embodiment, the Faraday cage container 1140 may be an opaque, lockable cabinet or case as shown in FIG. 11, or other suitable electromagnetic isolating container, that is further configured to isolate the emulation host system from external attacks, interventions or communications by way of sounds, vibrations, electro-magnetic emissions, thermal conditions such as hot spots, and light, such as lasers, to prevent side-channel attacks and communications from, or into, the emulation host system 1100 and libraries. Such interventions otherwise might be employed to defeat security of the emulation host system 1100 and libraries. System 1100 may include a set of external detection instruments 1130 configured to sense outside attacks, sense emissions from inside the Faraday cage 1140, such as emissions from the emulation host system 1110 or computer processing system 1125, or from internally housed power supplies (not shown in FIG. 11). The internally housed power supplies must be protected from tampering, because modulating power supply is a known Trojan type of trigger, payload, or both.

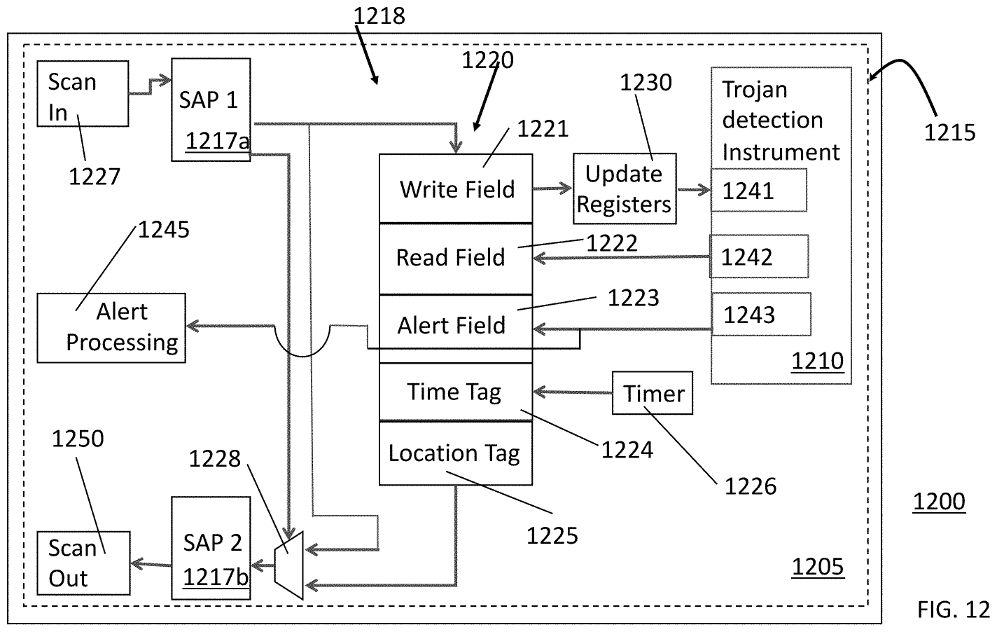

FIG. 12 is a simplified block diagram of a facility 1200 including a hardware trojan instrument system or facility 1205 (hereinafter “trojan instrument facility”), in an exemplary embodiment. Integrated circuit 1200 may include one or a plurality of trojan instrument facilities 1205 each placed or located at a corresponding trojan instrument location 1215. Trojan instrument facility 1205 may be configured to monitor a logic circuit (not shown) of the integrated circuit 1200. Trojan instrument facility 1205 may include a trojan detection instrument 1210 (“trojan instrument”) placed or located in a trojan instrument location 1215 in the integrated circuit 1200. The trojan instrument location 1215 may be a selected one of a plurality of predetermined predicted trojan instrument locations 1215 in the integrated circuit 1200. In some embodiments, the selected one of a plurality of predetermined predicted trojan instrument locations 1215 may be determined as a function of a trojan instrument prediction algorithm (not shown). In some embodiments, the trojan instrument prediction algorithm may be related to, or a function of, a hardware trojan prediction algorithm (not shown).

Referring to FIG. 12, the trojan detection instrument 1210 may be operable to compare a logic circuit output or logic circuit parameter against a reference limited threshold defined in relation to detecting hardware trojan activity. For example, at a location where a behavior modification trojan may be located and when activated may cause unexpected behavior of a logic circuit performing operations, the trojan detection instrument 1210 may include a timer for capturing a logic circuit parameter, which is the start to finish time for operations performed by the circuit. The trojan detection instrument 1210 also may include a stored reference limited threshold for worst-case time for the circuit to perform operations. The trojan detection instrument 1210 may compare the logic circuit parameter, which is the actual time captured for the circuit performing operations, against the reference limited threshold time. The trojan detection instrument 1210 may also consider a related logic circuit parameter, by maintaining a count of out-of-time events where the actual time captured for the circuit exceeds the reference limited threshold time. When the trojan detection instrument 1210 compares the logic circuit parameter (count of out-of-time events) to the reference limited threshold (maximum acceptable count of out-of-time events) and determines that the count or frequency of out-of-time events exceeds a reference limited threshold for that count or frequency determined or selected as differentiating delinquent operation from timely operation of the circuit, the trojan detection instrument 1210 then may output an alert data output or alert output. The alert data output may be received by an alert field 1223 of a scannable register 1220, as further described below. The trojan detection instrument 1210 may include analogous reference limited thresholds in relation to detecting hardware trojan activity, where the mode of operation of the trojan detection instrument differs, and where the possible hardware trojan functions in a different mode. For example, where a leaker-type trojan may be present, the trojan detection instrument may monitor activity of digital pins, for changes of logic level or state, changes of voltage level associated with logic level, for instructions, or temperature anomalies. For example, also, where a behavior modification-type trojan may be present, the trojan detection instrument may monitor rate of errors in internal data transfers, errors in time to perform operations, or both. Where a reliability-type trojan may be present, for example, trojan detection instrument may monitor rate of errors in internal data transfers, errors in time to perform operations, or both, or both, and may use circuit correctness assertions to detect faulty or erroneous fault-like or defect-like behavior.

Trojan instrument facility 1205 may include a plurality of scannable access points (1217a, 1217b) arranged in series. Trojan instrument facility 1205 may include one or more instrument interfaces 1218. Each instrument interface 1218 may include, or may be configurable for active operations with, a scannable register 1220. The scannable register 1220 may comprise register write field 1221, register read field 1222, register alert field 1223, register time tag 1224, and register location tag 1225. Trojan instrument facility 1205 may include a scan input 1227 connected to write field 1221 to provide write input thereto. Trojan instrument facility 1205 may include a write update register 1230 in communication with write field 1221 to receive write update from write field 1221 in relation to scan input 1227. Trojan detection instrument 1210 may include write input 1241 connected to write update register 1230 to receive write input commands or instructions from the write update register 1230.

Trojan detection instrument 1210 may include a plurality of bits, inputs and outputs. The trojan instrument plurality of bits may include instrument write input 1241, instrument read output 1242, and instrument alert output 1243. The instrument read output 1242 may be in communication with register read field 1222 to provide read output from the trojan instrument 1205 to register read field 1222. The instrument alert output 1243 may be in communication with register alert field 1223 to provide alert data output or alert output to register alert field 1223. Trojan detection instrument 1210 may be operable to detect the presence of a hardware trojan (not shown in FIG. 12) as a function of corruption of first data of the integrated circuit 1200. Trojan detection instrument 1210 may be operable to detect the presence of a hardware trojan (not shown in FIG. 12) as a function of comparing logic circuit output or a logic circuit parameter against a stored reference limited threshold defined in relation to detecting hardware trojan activity or hardware trojans.

Trojan instrument facility 1205 may include alert processing 1245 connected to receive output alert data directly from instrument alert output 1243, indirectly from register alert field 1223, or both. Trojan instrument facility 1205 may include a scan output 1250 connected to the shift-capture registers 1220 to receive output therefrom. Trojan instrument facility 1205 may include one or a plurality of scannable access points (1217a, 1217b). The plurality of scannable access points (1217a, 1217b) may be connected in series, accessible and selectable via a multiplexer 1228.

Scannable register 1220 may include location tag field 1224. Location tag field 1224 may store location tag data. The location tag data may identify a location of the trojan detection instrument 1210 in the integrated circuit 1200.

Scannable register 1220 may include time tag field 1225. Time tag field 1225 may store time tag data, such as time tag data for an event. The time tag data may be provided from a timer, counter, clock, or other timing data source 1226.

Trojan detection instrument 1210 may be placed or located in an instrument location 1215 in the integrated circuit 1200, chip, circuit board or electronic device. The instrument location 1215 may be a selected one of a plurality of predetermined predicted trojan instrument locations 1215 in the integrated circuit 1200, chip, circuit board or electronic device.

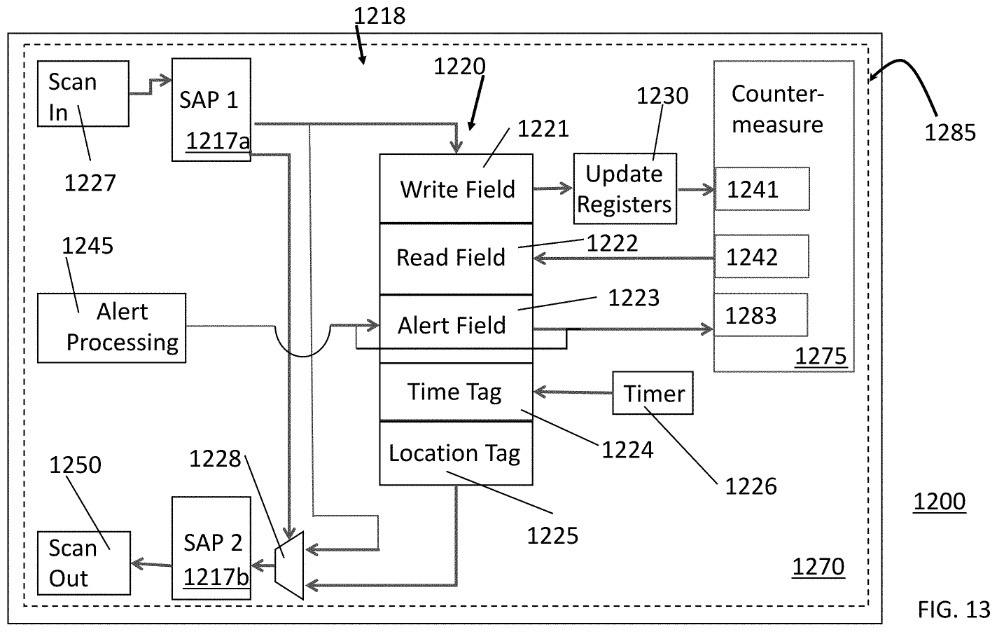

The trojan instrument facility 1205 may include alert logic configured to cause opening of, or to selectively open, an active one of the plurality of scannable access points (1217a, 1217b). The trojan instrument facility 1205 may be configured, in relation to opening the selected active scannable access point (1217a, 1217b), to insert the scannable register 1220 into an active scan chain associated with one of the plurality of instrument interfaces 1218. The trojan instrument facility 1205 also may be configured to provide the alert data output 1243 to alert processing 1245 logic outside the active scan chain, the register alert field 1223, or both. Referring to FIG. 13, the trojan instrument facility 1205 may be further configured to provide the output alert data to a countermeasure facility 1270 to activate countermeasure 1275.

In an embodiment, as shown in FIGS. 12-13, the trojan instrument facility 1205 may include, for example, trojan instrument facility 1205 having a scan path including shift and capture register elements 1220. The shift and capture register elements 1220 may be scannable cells. In embodiments, trojan instrument facility 1205 may be accessible via JTAG, IJTAG or JTAG-like boundary scan protocols, or other serial serial interfaces such as I2C or SPI.

In an embodiment, trojan instrument 1210 may produce read data output 1242 which is provided to the register read field 1222. Trojan instrument 1210 may produce alert data output 1243, which may be provided to the register alert field 1223, directly to alert processing logic 1245, or both. The register alert field 1223 may feed real-time alert system or logic 1245, countermeasure facility 1270, or both, (such as an interrupt processor) or may feed directly to countermeasure alert input or pin 1283 of countermeasure 1275.

Referring to FIG. 12, trojan instrument 1210 may receive commands or configuration inputs from the register write field 1221 via write update register 1230, into write input 1241. The trojan instrument facility 1205 may include one, or a plurality, of instrument interfaces 1218. The instrument interface 1218 may include a shift-capture register 1220. The register 1220 may include register write field 1221, register read field 1222, register alert field 1223, time tag 1224, and location tag 1225. In the illustrated arrangement, the time tag 1224 originates from a timer, clock or timing data source 1226 synchronized to system or unit operations of integrated circuit 1200. The location tag 1225 may be a numerical value assigned to a position in the integrated circuit 1200, such as during layout of the integrated circuit 1200, indicating a location where trojan instrument 1210 is placed or located. In an embodiment, the location tag 1224 may be a number that represents, at minimum, an X-Y location within the integrated circuit 1200, electronic device including integrated circuit 1200, circuit board, or electronic system. In an embodiment, the location tag 1224 may also be associated with other information relevant to locating the trojan instrument 1210 in the integrated circuit 1200, such as design module name.

Referring to FIG. 12, in embodiments, trojan instrument 1210 may be analog or digital. If the trojan instrument 1210 is analog, then an analog to digital conversion is performed between the instrument interface shift-capture registers 1220 and the trojan instrument 1210, or within the trojan instrument 1210, so the trojan instrument data output is represented to the data collection instrument interface or shift-capture registers 1220 as digital data.

Referring to FIG. 13, integrated circuit 1200 may include a countermeasure instrument system or countermeasure facility 1270. Referring to FIG. 13, countermeasure facility 1270 may include countermeasure instrument or countermeasure 1275.

Countermeasure 1270 may be placed or located in a countermeasure location 1285 in the integrated circuit 1200. The countermeasure location 1285 may be a selected one of a plurality of predetermined predicted countermeasure locations in the integrated circuit 1200. In some embodiments, the selected one of a plurality of predetermined predicted countermeasure locations 1285 may be determined as a function of a countermeasure prediction algorithm.

As shown in FIGS. 12 and 13, the countermeasure facility 1270 may be in communication with trojan instrument facility 1205. In embodiments, for example, the countermeasure 1275 may be configured to receive processed alert data at alert data input 1283 (FIG. 13), where the processed alert data originates at the alert data output of trojan instrument 1210 (shown in FIG. 12). Referring to FIG. 13, the processed alert data may be provided to alert data input 1283 of countermeasure 1275 from alert processing logic 1245, register alert field 1223, or both.

Referring to FIG. 13, countermeasure 1275 may include countermeasure instrument structure configured to perform a countermeasure function in relation to receiving processed alert data at alert data input 1283. In an embodiment as described elsewhere herein, for example, where a behavior modification trojan may be present in the integrated circuit 1200 and when activated may cause unexpected behavior of a logic circuit performing operations and being monitored, and the trojan detection instrument 1210 is configured to determine and count time-bounded operation or event errors, the countermeasure 1275 (shown in FIG. 13) may include an error correction unit providing error corrections, redundant voting circuits and redundant or spare modules which may be activated, or both. In an embodiment where a leaker-type trojan may be present in the integrated circuit 1200, and the trojan detection instrument 1210 may monitor for a logic circuit, the activity of digital pins for changes of logic level or state, the countermeasure 1275 (shown in FIG. 13) may include countermeasure structure configured to perform deactivation of unused digital pins that have been determined to be active when not in use for a known or designed purpose. In embodiments where a behavior modification-type trojan may be present in the integrated circuit 1200, and the trojan detection instrument 1210 may monitor for a logic circuit, the rate of errors in internal data transfers, errors in time to perform operations, or both, the countermeasure 1275 (shown in FIG. 13) may include an error correction unit providing error corrections. In embodiments where a reliability-type trojan may be present, for example, and the trojan detection instrument 1210 may monitor rate of errors in internal data transfers, errors in time to perform operations, or both, the countermeasure 1275 (shown in FIG. 13) may include an error correction unit providing error corrections.

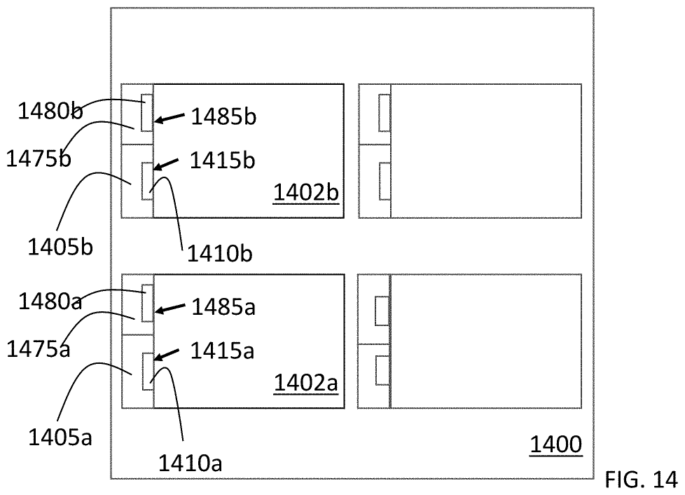

FIG. 14 is a simplified block diagram illustrating a facility 1400 including a plurality of trojan instrument facilities (1405a, 1405b) and a plurality of countermeasure facilities (1475a, 1475b), in an exemplary embodiment. Integrated circuit 1400 may include a plurality of logic circuits (1402a, 1402b) monitored for protected operation where one or more hardware trojans (not shown) may be present in the logic circuit. It will be understood that each of the nefarious hardware trojans is subject to being activated by a trigger to provide a trojan payload performing an improper trojan function. The plurality of hardware trojans (not shown) will be located at predicted or known hardware trojan locations (not shown) in the logic circuits (1402a, 1402b). Integrated circuit 1400 may include a first trojan instrument facility 1405a configured to monitor the first logic circuit 1402a to detect or determine first trojan activity of the respective first hardware trojan (not shown). First trojan instrument facility 1405a may include first trojan instrument 1410a located at first instrument location 1415a. The type and function of first trojan instrument 1410a may be determined in relation to a prediction, possibility, or information known about the type or category, structure, function or signature of the first hardware trojan (not shown). The first hardware trojan (not shown), for example, may be one of the following types or categories: data leakage, behavior modification, or reliability impairment. The first hardware trojan location (not shown) in the monitored first logic circuit 1402a may be known, identified, determined, or predicted by a prediction algorithm. The first instrument location 1415a may be selected in relation to the first hardware trojan location (not shown), category or function of the first hardware trojan (not shown), or both. Integrated circuit 1400 may include a first countermeasure facility 1475a configured to protect the first logic circuit 1402a. The first countermeasure facility 1475a includes a first countermeasure 1480a that is activated when the first detection instrument 1410a provides alert data output in relation to identifying, detecting or determining activity that is, or may be, associated with the presence of a first hardware trojan. First countermeasure facility 1475a may include first countermeasure 1480a located at first countermeasure location 1485a. The type and function of first countermeasure 1480a, and first countermeasure location 1485a, may be determined in relation to a prediction, possibility, or information known about the type or category, structure, function or signature of the first hardware trojan (not shown) at the known, determined or predicted first hardware trojan location (not shown) in first logic circuit 1402a. The first countermeasure 1480a may be of the types or categories described elsewhere herein for countering or defeating hardware trojans of the category (data leakage, behavior modification, or reliability impairment) that is known, determined or predicted for the first hardware trojan (not shown). The first trojan instrument facility 1405a and first countermeasure facility 1475a are in communication, at least, to provide alert data from the first trojan instrument facility 1405a to the first countermeasure facility 1405b, for activating the first countermeasure 1480a when first hardware trojan activity is detected by first trojan instrument 1410a.

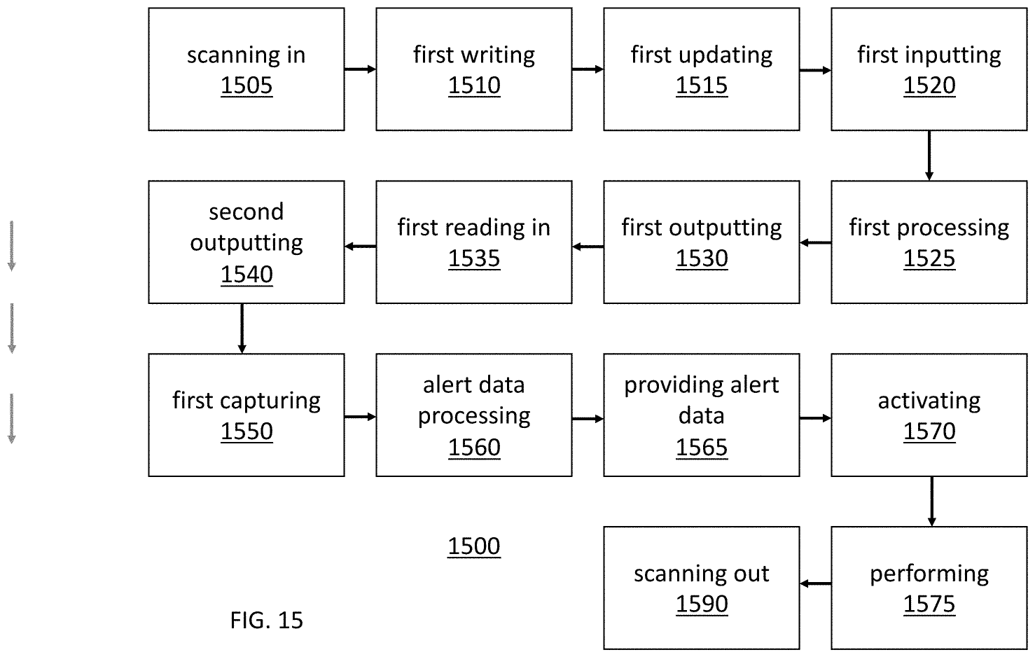

FIG. 15 is a simplified flow diagram of a method 1500 for operating a facility including a trojan instrument system or facility, in an exemplary embodiment. It will be understood that, in embodiments, the subject integrated circuit of method 1500 may be identical to integrated circuit 1200 shown in FIGS. 12-13, and may include a trojan instrument facility and countermeasure facility identical to trojan instrument facility 1205 (FIG. 12) and countermeasure facility 1270 (FIG. 13) described elsewhere herein. The subject trojan instrument facility and countermeasure facility of the integrated circuit of method 1500 may include instrument interfaces and shift-capture registers, identical to those elsewhere described herein for integrated circuit 1200.

Referring to FIG. 15, method 1500 may include scanning in 1505 scan input data of an input vector at a scan input port for a shift-capture register. The scan input data may be a function of operations of the integrated circuit having the trojan instrument system located therein, or an electronic system including the integrated circuit. Method 1500 may include first writing 1510 scan input data to a write field of the shift-capture register. Method 1500 may include first updating 1515 write update data in a write update register from the write field of the shift-capture register. Method 1500 may include first inputting 1520 write input data from the write update register into the trojan instrument, via a write input pin of the trojan instrument. Method 1500 may include first processing 1525 scan chain data, by the trojan instrument, in relation to the write input data. Method 1500 may include first outputting 1530 read scan chain data from the trojan instrument, via a read output pin of the trojan instrument. Method 1500 may include first reading in 1535 the read scan chain data, into a read field of the shift-capture register, from the read output pin of the trojan instrument. Method 1500 may include second outputting 1540 captured scan chain data from the trojan instrument, via a capture output pin of the trojan instrument. Method 1500 may include first capturing 1550 the captured scan chain data, into fields of the shift-capture register. Method 1500 may include alert data processing 1560, by alert processing logic, of alert data output from the alert field of the shift-capture register, or directly from the alert data output to alert processing logic as a function of the trojan instrument detecting activity consist with the presence of a hardware trojan by the trojan instrument. Method 1500 may include providing 1565 alert data from the register alert field or directly from trojan detection instrument, to an alert data input of a countermeasure. Method 1500 may include activating 1570 the countermeasure in relation to providing 1565 the processed alert data. Method 1500 may include the performing 1575 a countermeasure function by the countermeasure in relation to activating 1570 the countermeasure in relation to providing 1565 the processed alert data to the countermeasure. Method 1500 may include scanning out 1590 scan output data from the shift-capture register, at a scan output port.

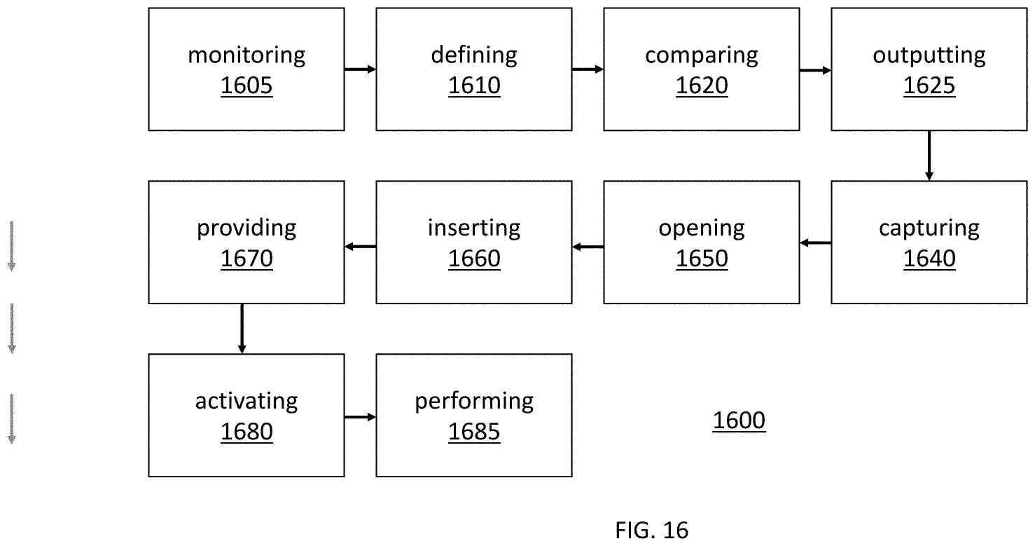

FIG. 16 is a simplified flow diagram of a method 1600 for protected operation of a facility including a trojan instrument facility and countermeasure system, in an exemplary embodiment. It will be understood that, in embodiments, the subject integrated circuit of method 1600, including the trojan instrument facility and countermeasure facility thereof, may be identical to integrated circuit 1200 including trojan instrument facility 1205 and countermeasure 1270, as shown in FIGS. 12-13 and described elsewhere herein. The subject trojan instrument facility may include a plurality of scannable access points arranged in series. The subject trojan instrument facility may include one or a plurality of instrument interfaces. Each of the instrument interfaces may include a scannable register such as, for example, a shift-capture register including a plurality of scan cells. The scannable register may include an alert field. The alert field may be adapted to selectively open an active one of the plurality of scannable access points. It will be understood that the subject trojan instrument facility, countermeasure facility, or both, processing alert data from the alert field, may selectively open or may cause selective opening, of an active one of the one or plurality of scannable access points. The subject trojan detection instrument may be operable to monitor a logic circuit of the integrated circuit that is subject of method 1600. The trojan detection instrument may be operable to compare a logic circuit output or parameter against a reference limited threshold. The reference limited threshold may be defined in relation to detecting hardware trojan activity. The trojan detection instrument may be operable to output alert data in relation to comparing the logic circuit output or parameter against the reference limited threshold.

Method 1600 may include monitoring 1605 the logic circuit, by the trojan instrument facility. Method 1600 may include defining 1610 a reference limited threshold in relation to detecting hardware trojan activity, in the trojan detection instrument. Method 1600 may include comparing 1620, by the trojan detection instrument, logic circuit output against the reference limited threshold. Method 1600 may include the trojan detection instrument outputting 1625 alert data output as a function of said comparing 1620. Method 1600 may include capturing 1640 the alert data output, by the alert field of said scannable register. Method 1600 may include opening 1650 an active one of the plurality of scannable access points, as a function of the capturing 1640 the alert data output, by the alert field. Method 1600 may include, as a function of the opening 1650, inserting 1660 the scannable register into an active scan chain with an associated one of said plurality of instrument interfaces. Method 1600 may include providing 1670 the alert data output to alert processing logic outside the active scan chain. Method 1600 also may include activating 1680 the countermeasure responsive to the countermeasure receiving the alert data output. Method 1600 may include performing 1685 the countermeasure function by the countermeasure, responsive to activating 1680 the countermeasure in relation to providing 1670 the alert data output.

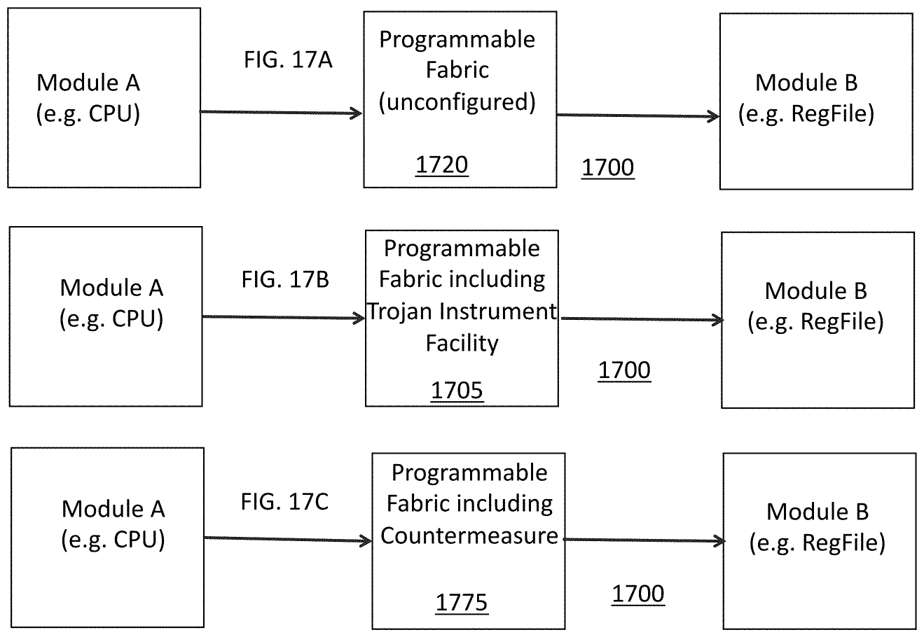

FIG. 17A is a simplified block diagram illustrating a facility 1700 including an unconfigured programmable fabric 1720, in an exemplary embodiment. FIG. 17B is a simplified block diagram of the integrated circuit shown generally in FIG. 17A, with the programmable fabric including a secured trojan instrument facility. FIG. 17C is a simplified block diagram of the integrated circuit shown generally in FIG. 17A, with the programmable fabric including a secured countermeasure facility. Integrated circuit 1700, trojan instrument facility 1705 and countermeasure facility 1775 may be identical to the integrated circuits, trojan instrument facilities and countermeasure facilities in embodiments described and illustrated elsewhere in this disclosure, except as otherwise described in this paragraph or shown in FIGS. 17A-17C. As shown in FIG. 17A, integrated circuit 1700 may include the unconfigured programmable fabric 1720 located in one or a plurality of areas or locations where each secured trojan instrument facility and secured countermeasure facility will be placed or installed to monitor and protect logic circuits. Integrated circuit 1700 may be designed, processed and manufactured in an untrusted facility. Integrated circuit 1700 may include a plurality of unverified logic blocks and circuits licensed from untrusted third parties under licenses for Intellectual Property Cores (IP Cores). The unconfigured programmable fabric 1720 (shown in FIG. 17A) may be installed in the design, processing and manufacturing of a processed silicon chip (not shown) having integrated circuit 1700 formed thereupon, in untrusted facilities. The integrated circuit 1700 including unconfigured programmable fabric 1720 may be tested in accordance with regular testing procedures for QA/QC of integrated circuits, in an untrusted facility. The silicon chip including integrated circuit 1700 thereafter may be delivered to a trusted, secure facility. As shown in FIG. 17B, the integrated circuit 1700 may include the programmable fabric having the secured trojan instrument facility 1705 installed in the trusted, secure facility according to secure installation procedures. As shown in FIG. 17C, the integrated circuit 1700 may include the programmable fabric having the secured countermeasure facility 1775 installed in the trusted, secure facility according to secure installation procedures. The integrated circuit 1700 thus may be monitored and protected by having the secured trojan instrument facility 1705 and secured countermeasure facility 1775 installed in the programmable fabric 1720 in relation to a predetermined secure installation procedure in the trusted, secure facility. The secured trojan instrument facility 1705 and secured countermeasure facility 1775 thus may be installed in programmable fabric 1720 in a trusted, secure facility, whereas the processed silicon chip including integrated circuit 1700 may include unverified, licensed IP Cores embodied in licensed logic blocks and circuits, which may be designed, processed, manufactured, and tested in untrusted facilities outside control of the finished product manufacturer. The finished product thus may include the monitored and protected integrated circuit and/or an electronic device, circuit board, or electronic system including the same.
[-----------Begin New Text-----------]

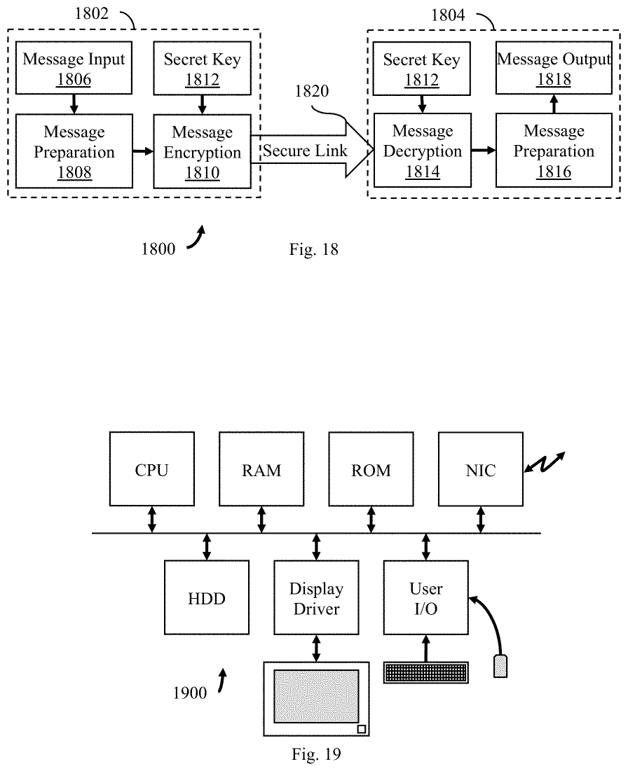

Illustrated in FIG. 18 is a simplified system diagram of a secure messaging system 1800 for analyzing the security of a target facility (not shown), in an exemplary embodiment. The secure messaging system 1800 includes send facility 1802, receive facility 1804, and secure link 1820. The send unit 1802 includes message input facility 1806, message preparation facility 1808, message encryption facility 1810, and secret key 1812. The receive unit 1804 includes message decryption facility 1814, message preparation facility 1816, message output facility 1818, and a copy of secret key 1812. In this exemplary embodiment, the system represents a secure messaging system whereby a user types a message on a terminal, e.g., message input facility 1806. The message is then converted from ASCII to packets by message preparation facility 1808, encrypted by message encryption facility 1810 using secret key 1812, and is sent across secure link 1820. The encrypted message sent across secure link 1820 is received by receive unit 1804, decrypted by message decryption facility 1814 using the copy of secret key 1812, and is structured for by message preparation facility 1816, e.g., converting the received packets to ASCII text, and provided for receiving or viewing by message output facility 1818. This messaging system is largely digital and can be used to explore and analyze digital Trojans.

FIG. 19 illustrates, in block diagram form, an exemplary general-purpose computing system 1900 adapted to instantiate any of the several embodiments. As is known, computing system 1900 may be adapted to function as send facility 1802, as receive facility 1804, or as both.

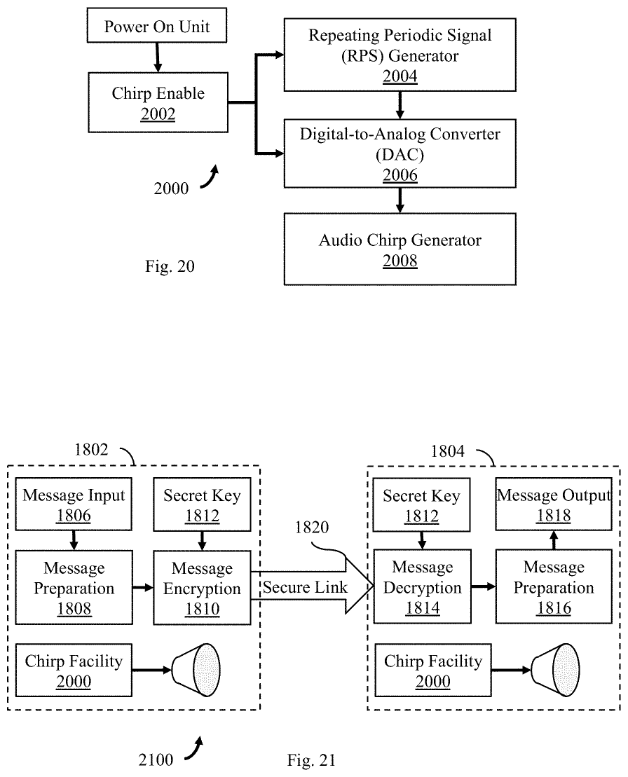

FIG. 20 illustrates, in block diagram form, is an analog chirp facility 2000 that may be added to the secure messaging system 1800 of FIG. 18. The chirp facility 2000 provides an analog circuit that would produce an audible chirp noise whenever the system is on and active, thereby informing all within hearing range that the system is being used. This may be viewed as a security feature that would audibly notify concerned individuals that someone not authorized was attempting to use the messaging system. According to one embodiment, applying power to the secure messaging system 1800 of FIG. 18 also enables the audible “chirp” generator, e.g., activates the chirp enable 2002 of the chirp facility 2000. Upon activation of the chirp enable 2002, the repeating periodic signal (“RPS”) generator 2004 may generate a sequence of digital data value that may be provided to the Digital-to-Analog Converter (DAC) 2006 to generate a stream of analog pulses, each of time tₚ in length, where tₚ is an integer value. DAC 2006 may be connected to an audio chirp generator 2008 via an analog communication connection, e.g., a coaxial cable. Audio chirp generator 2008 receives and counts the stream of analog pulses and generates an audible “chirp” at a specified time T_{c}, where T_{c} is an integer value. By way of example, if tₚ is 164 microseconds (μs) and T_{c} is 30 seconds (s), an audible chirp will be generated when 182,926 analog pulses have been counted. Other embodiments are anticipated. By way of example, according to a different embodiment, the stream of analog pulses may be generated by a rotating mechanical device where the rotation moves magnets and wire coils causing an analog signal to be generated. FIG. 21 illustrates, in block diagram form, the secure messaging system 1800 of FIG. 18 with the chirp facility 2000 integrated into the send facility 1802 and the receive facility 1804.

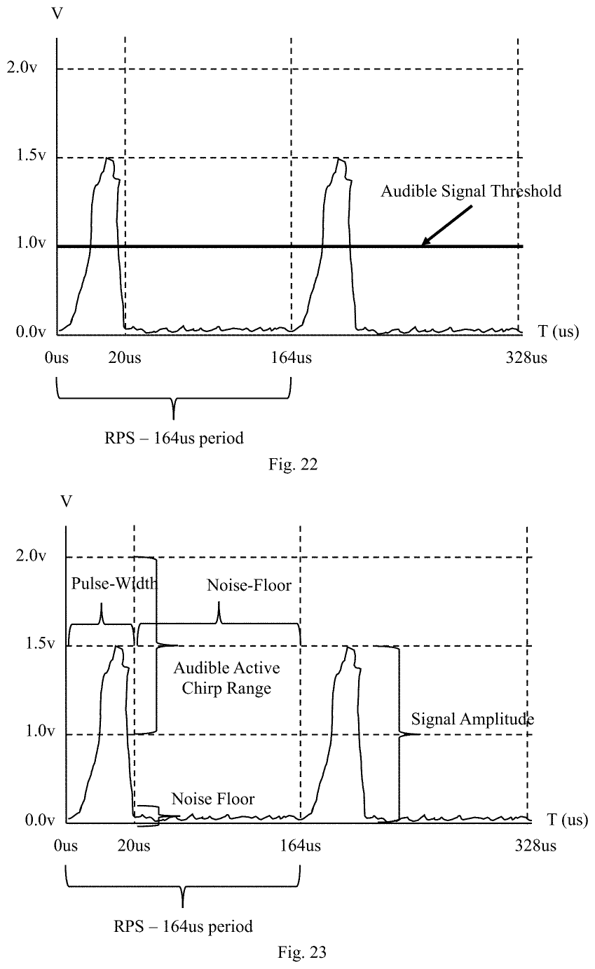

FIG. 22 illustrates, in waveform, the analog output of the chirp facility 2000 of FIG. 20 according to some embodiments. The waveform used in this example is an RPS, e.g., an identical copy of the waveform is produced and delivered every tₚ, e.g., every 164 us as illustrated in the exemplary drawing. Alternate embodiments of RPS with alternate tₚ are anticipated. FIG. 22 also illustrates an exemplary audible threshold, whereby audible threshold is defined as any voltage waveform component that falls below the threshold, illustrated here in this particular exemplary embodiment as 1.0 v, will not accumulate and produce an audible tone when delivered to the audio chirp generator 2008 of FIG. 20, and, any voltage waveform that exceeds the threshold will accumulate and will produce and audible tone when delivered to the audio chirp generator 2008 of FIG. 20.

FIG. 23 illustrates, in waveform, exemplary parameters of the analog output of the chirp facility of FIG. 20 according to some embodiments. By way of example, the exemplary voltage waveform may be generated with a minimum amplitude of 0.0 volts and a maximum amplitude of 2.0 volts with an amplitude error consideration of +/−0.05 volts. According to this embodiment, under normal conditions, the operational amplitude of the analog pulse to create an audible sound is 1.5 volts, which exceeds the threshold voltage level shown in FIG. 3. The other axis of consideration is time. The repeating period is 164 microseconds, the pulse-width of the analog pulse is 20 microseconds, and the noise-floor segment of the analog pulse is 144 microseconds. Every 164 microseconds, the overall analog waveform is repeated. Note that these parameters may be completely different on other embodiments of repeating periodic signals, but the discussion that follows is just as applicable to different embodiments of repeating periodic signals.

The subsystem of FIG. 20 represents an analog feature that may be subject to analog, parametric and environmental trojans. By way of example, one potential attack by a trojan that uses modification of the parameters defining the RPS is to modulate the RPS so as to leak out data associated with the messaging system, and at the same time, causing no disruption of the normal audible chirp function. Several way to implement such an analog/parametric attack are explored in the following paragraphs.

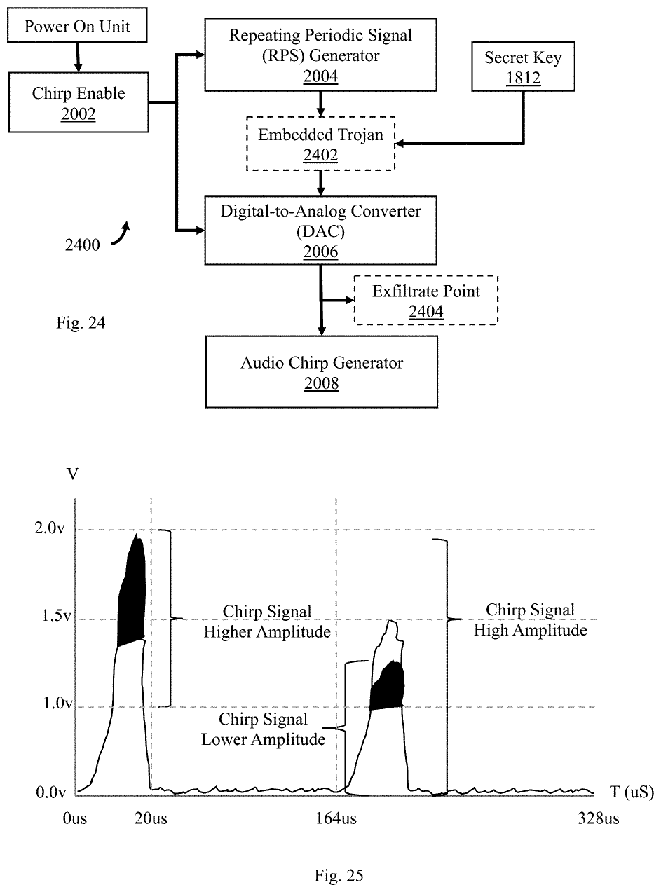

FIG. 24 illustrates, in block diagram form, an infected chirp facility 2400 according to some embodiments. The infected chirp facility 2400 includes the chirp facility 2000 of FIG. 20, an embedded trojan 2402, and an exfiltrate point 2404. As discussed earlier, the chirp facility 2400 may be associated with the secure messaging system 1800 of FIG. 18 and function to generate an audible “on and active” chirping sound. According to this embodiment, an embedded trojan 2402 has been placed between the RPS generator 2004 and the DAC 2006 wherein the embedded trojan may inject the digital secret key data into the RPS signal by modifying the signal provided to the DAC 2006. An exfiltration of that data, illustrated in this embodiment as exfiltrate point 2404, may be accomplished by monitoring the connecting communications channel between the DAC 2006 and the audio chirp generator 2008, e.g., monitoring an SMA connector that may connect the output of the DAC 2006 to the audio chirp generator 2008, according to at least one embodiment. By way of example, a nefarious individual may connect a splitter to the physical connector and can directly monitor the signal produced by the DAC 2006 by using an oscilloscope or other electronic device for viewing analog signals, as it passes through to the audio chirp generator 2008.

FIG. 25 illustrates, in waveform, the analog output of the chirp facility 2000 of FIG. 20 having been modified by the embedded trojan 2402 of FIG. 24 and observed at exfiltrate point 2404 of FIG. 24 using amplitude modification, according to some embodiments. More specifically, FIG. 25 illustrates how voltage amplitude modulation can be used to modify the RPS to change the shape of the waveform, but still allow the normal audible chirp to be generated, thereby “leaking” data by way of exfiltrate point 2404. By way of example, an exemplary audible threshold voltage may be 1.0V as illustrated in FIG. 22, and an exemplary operational amplitude of the analog pulse to create an audible sound may be 1.5 volts, as illustrated in FIG. 23. For this exemplary embodiment, embedded trojan 2402 may alter the data delivered from RPS generator 2004 thereby increasing the amplitude of the analog pulse delivered by DAC 2006 to audio chirp generator 2008 to take on a value between 1.5 v and 2.0 v as illustrated in FIG. 25, and labeled “Chirp Signal Higher Amplitude”. This increase in amplitude may be observed at exfiltrate point 2404, as discussed previously. This change in the amplitude of the chirp signal may represent a logic 1 that may be observed at exfiltrate point 2404, all the while still meeting the input parameters of the audible chirp generator. Likewise, embedded trojan 2402 may alter the data delivered from RPS generator 2004 thereby decreasing the amplitude of the analog pulse delivered by DAC 2006 to audio chirp generator 2008 to take on a value greater than 1.0 v and less than 1.5 v as illustrated in FIG. 25, and labeled “Chirp Signal Lower Amplitude”. This decrease in amplitude may be observed at exfiltrate point 2404, as discussed previously. This change in the amplitude of the chirp signal may represent a logic 0 that may be observed at exfiltrate point 2404, all the while still meeting the input parameters of the audible chirp generator. Over subsequent repeating periods, the digital representation of the whole of the secret key can be leaked out. If the secret key is 128-bit extended American Standard Code for Information Interchange (ASCII) letters/numbers/symbols, and each extended ASCII character is represented with a number that takes up 8 digital bits, then the whole secret key may be leaked out in 1024 RPS frames. Observations of the analog pulse delivered from DAC 2006 to audio chirp generator 2008 by a nefarious individual monitoring the signal will see that each pulse presented will have a different shape or size and this change in shape and size can be interpreted as logic is and logic 0s.

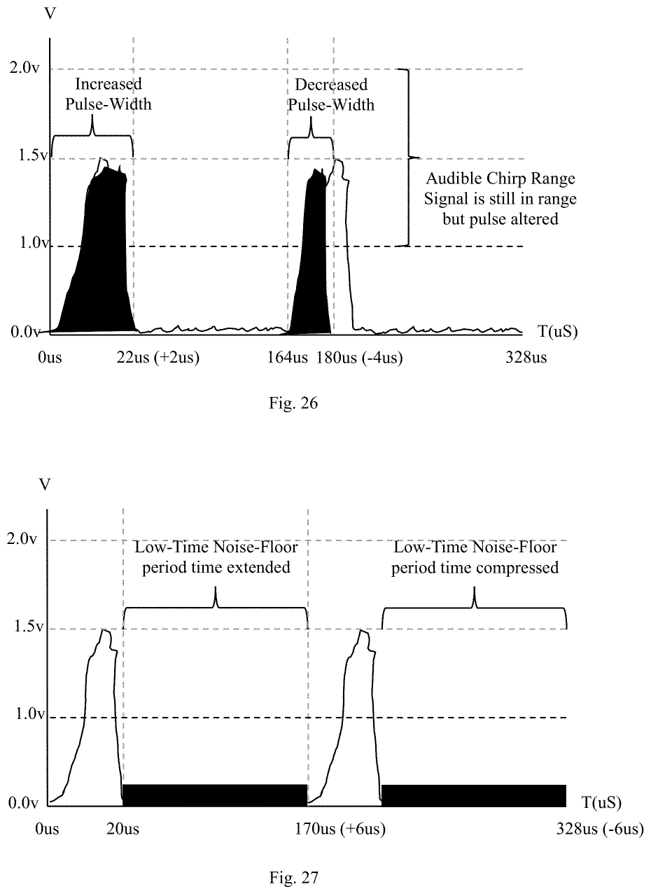

FIG. 26 illustrates, in waveform, the analog output of the chirp facility 2000 of FIG. 20 having been modified by the embedded trojan 2402 of FIG. 24 and observed at exfiltrate point 2404 of FIG. 24 using pulse-width modification, according to some embodiments. More specifically, FIG. 26 illustrates how voltage pulse-width modulation can be used to modify the RPS to change the shape of the waveform, but still allow the normal audible chirp to be generated, thereby “leaking” data by way of exfiltrate point 2404. By way of example, for this embodiment, embedded trojan 2402 may alter the data delivered from PRS generator 2004 thereby altering the pulse width of the high-time of the analog pulse delivered by DAC 2006 to audio chirp generator 2008, represented in FIG. 26 as an increase of the pulse width by 2 us and labeled as “Increased Pulse-Width”. This increase in the pulse width may be observed at exfiltrate point 2404, as discussed previously, and may represent a logic 1 to a nefarious observer, all while maintaining the input parameters of the audible chirp generator 2008. Likewise, embedded trojan 2402 may alter the data delivered from RPS generator 2004 thereby decreasing the pulse width of the analog pulse delivered by DAC 2006 to audio chirp generator 2008 so as to decrease the pulse width by 4 us, here labeled as “Decreased Pulse-Width”. This decrease from the standard 20 us to 16 us in the high-time of the analog pulse may be observed at exfiltrate point 2404, as discussed previously, and may represent a logic 0 to a nefarious observer, all while maintaining the input parameters of the audible chirp generator 2008. Over subsequent repeating periods, the digital representation of the whole of the secret key can be leaked out. If the secret key is 128-bit extended ASCII letters/numbers/symbols, and each extended ASCII character is represented with a number that takes up 8 digital bits, then the whole secret key may be leaked out in 1024 RPS frames.

FIG. 27 illustrates, in waveform, the analog output of the chirp facility 2000 of FIG. 20 having been modified by the embedded trojan 2402 of FIG. 24 and observed at exfiltrate point 2404 of FIG. 24 using manipulation of time within the RPS noise-floor, according to some embodiments. More specifically, FIG. 27 illustrates a manipulation of the amount of time within the RPS that represents a noise-floor. Referring to FIG. 22, the pulse occurs in the first 20 microseconds and there is a quiescent period of 144 microseconds until the next RPS frame occurs. This quiescent period, e.g., the low-voltage time, may be manipulated in a similar manner as the pulse-width modulation discussed previously, but without compensating for the additional time added to the quiescent period of the RPS, e.g., maintaining the time period of the RPS frame at exactly 164 us. By way of example, referring back to FIG. 27, the embedded trojan 2402 may alter the data delivered from the RPS generator 2004 to the DAC 2006 to extend the quiescent period of the RPS to 150 us, thus extending the overall RPS period to 170 us. This increase in the RPS period may be observed at exfiltrate point 2404 and interpreted to represent a logic 1. Likewise, the embedded trojan 2402 may alter the data delivered from the RPS generator 2004 to the DAC 2006 to compress the quiescent period of the RPS to 138 us, thus reducing the overall RPS period to 158 us. This increase in the RPS period may be observed at exfiltrate point 2404 and interpreted to represent a logic 0. This changing of the repeating period time of each RPS frame to indicate data values represents a manipulation that could be viewed as frequency modulation. Over subsequent repeating periods, the digital representation of the whole of the secret key can be leaked out. If the secret key is 128 extended ASCII letters/numbers/symbols, and each extended ASCII character is represented with a number that takes up 8 digital bits, then the whole secret key may be leaked out in 1024 RPS frames.

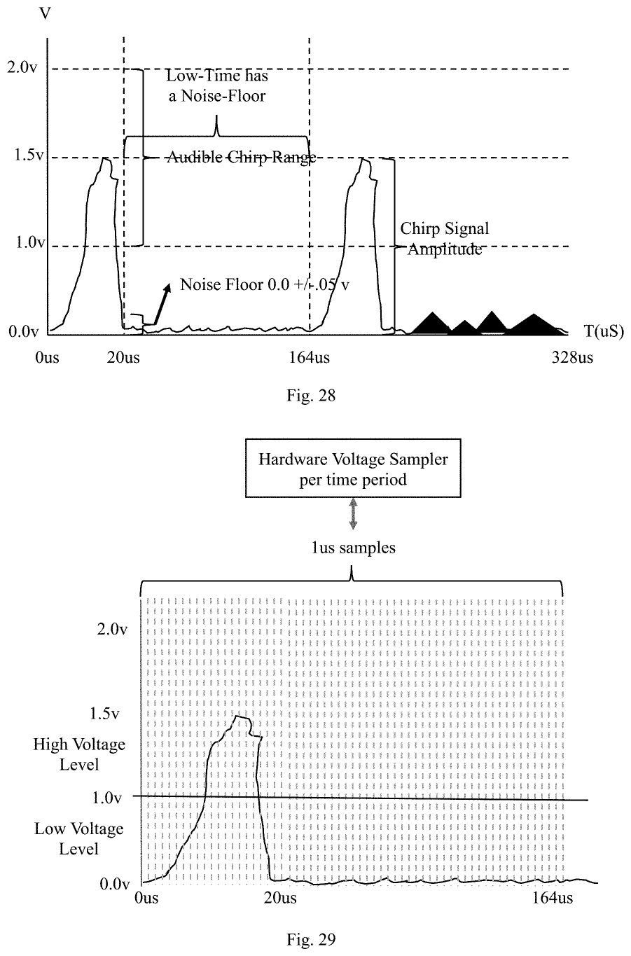

FIG. 28 illustrates, in waveform, the analog output of the chirp facility 2000 of FIG. 20 having been modified by the embedded trojan 2402 of FIG. 24 and observed at exfiltrate point 2404 of FIG. 24 using manipulation of the noise-floor level that can be used to exfiltrate data, according to some embodiments. In the analog RPS generator 2004 and audio chirp generator 2008 shown in FIG. 20, as long as the low-voltage noise-floor signal remains below the audible threshold of 1.0 volts, the audio chirp generator 2008 will not produce an analog signal of size and duration that will produce a pulse count that results in the generation of an audible sound. The digital ASCII secret key values can be used to directly manipulate the noise-floor voltage level as long as the voltage amplitude remains below 1.0 v. Once the secret key begins to be applied to the noise-floor, then a value of 0.5 v could be used to represent a logic 1 and a value of 0.2 v or lower could be used to represent a logic 0. The time-limitation that represents the logical value depends on, for example, the conversion rate of the DAC being used to modulate the noise-floor. For example, a logic 1 could be represented by a voltage value of 0.5 v for a time value of 5 us if the DAC conversion rate is less than 5 us. This means that 28 digital bits could be leaked in one RPS frame. Since the secret key used in this example is 1024 bits long, then to exfiltrate the secret key once will require 37 RPS frames. This method is a more efficient exfiltration mechanism than the other three.

Given that a RPS can be attacked and manipulated using several different methods, amplitude modulation, pulse-width modulation, frequency modulation and noise-floor modulation, and leaves no observable functional or operative evidence of manipulation, the ability to detect such manipulations requires a comprehensive instrument that can detect modifications in any of the RPS waveform's parameters. The brute force method to monitor and verify and analog signal would be to sample the waveform and to compare the sampled waveform exactly to the pristine expectation of a perfect waveform.

FIG. 29 illustrates a simple hardware sampling function that can produce a large volume of data that could be used to feed a brute force method whereby the collected samples are used to recreate the waveform for comparison. However, there are issues with this sort of technique whether it is accomplished externally using a hardware or a software process or embedded within the device using a hardware process. One exemplary issue is if the waveform is sampled and then that sample is exported from the device so that an external software process can be used to do an “exact match” comparison, there is a high-bandwidth requirement for the process, and there is a high latency period since the process is external to the device.

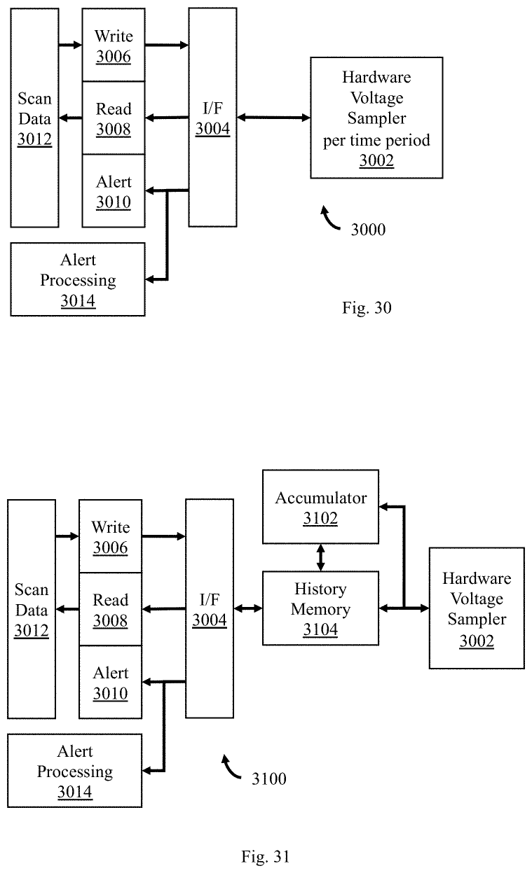

FIG. 30 illustrates, in block diagram form, a hardware access facility 3000 adapted to capture and export the sample data generated by the hardware sampling function of FIG. 29. Hardware access facility 3000 may include a hardware voltage sampler 3002, e.g., an ADC, an interface facility 3004, and, analogous to the trojan instrument facility 1205 of FIG. 12, may include a register write field 3006, register read field 3008, register alert field 3010, and may also include an interface to the scan chain in the system, here represented by scan data 3012. During operations, each sample acquired by the hardware voltage sampler 3002 may require a time-tag to indicate where in time within the RPS the sample was taken. By way of example, for and RPS that is 164 us in length, sampling at a 1 us sample rate would require an 8-bit digital value to represent a count up to 256. Each sample acquired by the hardware voltage sampler 3002 may require a voltage level at the sampling time which may be implemented using a 12-bit ADC with a 12-bit precision rating as the sampling mechanism. Furthermore, if modification or manipulations of the waveform require 1024 RPS frames to explore the full extent of the manipulations, then it requires another 10-bit digital value that can produce a count up to 1024 in order to count the value of which sampled RPS frame the sample resides within. Overall, this mean that each sample would require a minimum of 30 bits (8-bit sample count+12-bit ADC output+10-bit RPS count) to define the size and location in the sample space of the sample. According to this embodiment, the number of samples required to capture the entire range over which the nefarious manipulations or modifications take place is 164 us sample multiplied by the 1024 RPS frames, or 167,936 samples. For each sample of 30 bits, the total bits needed would be 5,038,080 bits. If the sampling must be conducted multiple times to capture the manipulations multiple times, then the process requires multiples of over 5 million bits to be exported and processed to evaluate if any illicit changes have been made to the waveform.

If the waveform is sampled and embedded on-device hardware instrument 3000 is used to process all of the sampled data to recreate the waveform exactly from the samples and to conduct a direct comparison, then this type of instrument is too large, consumes too much power, and may also include a large storage and processing latency. In reality, the goal of an embedded cybersecurity instrument to observe any analog waveform for any nefarious manipulation needs to be designed for detection, not sample and duplication and exact comparison (with error bounds) of the waveform.

FIG. 31 illustrates, in block diagram form, a hardware instrument 3100 adapted to evaluate an RPS according to some embodiments. More specifically, hardware instrument 3100 may be adapted to evaluate an RPS without requiring a high bandwidth or an instrument that may be effectively as large as the functional unit that produces the functional RPS. As with the hardware access facility 3000 of FIG. 30, hardware trojan instrument facility 3100 may include a hardware voltage sampler 3002, e.g., an ADC, an interface facility 3004, and, analogous to the trojan instrument facility 1205 of FIG. 12, may include a register write field 3006, register read field 3008, register alert field 3010, and may also include an interface to the scan chain in the system, here represented by scan data 3012. Additionally, hardware instrument 3100 may include an accumulator 3102, and a history memory 3104. During operations, each sample acquired by the hardware voltage sampler 3002 is provided to the accumulator 3102. The accumulator may accumulate the samples over a selected period of time and may then provide an average of those samples for the selected period of time to history memory 3104. The history memory 3104 may provide the average of the samples to interface 3004 which provides access to the scan data 3012 by way of read register 3008. According to this embodiment, the accumulator 3102, or an integrator according to some embodiments, may limit the sample space to certain evaluation variables. The important aspects of the simplified waveform diagrams in FIG. 22 and FIG. 23 are the repeatability of the RPS frame, and the timing and voltage points that cause the analog signal to be observable by its functional process, e.g., changes that may cause the audible signal to be denied, and changes that may cause the audible signal to occur and occur at the wrong time. By way of example, there is a clearly defined audible signal threshold, e.g., 1.0V, and the waveform can be segmented into the pulse segment, e.g., the first 20 us, and the noise-floor segment, e.g., the remaining 144 us. Using the audible signal threshold and the waveform segments, the evaluation space may then be segmented into these 4 quadrants, thus maximizing detection and minimizing the data requirement.

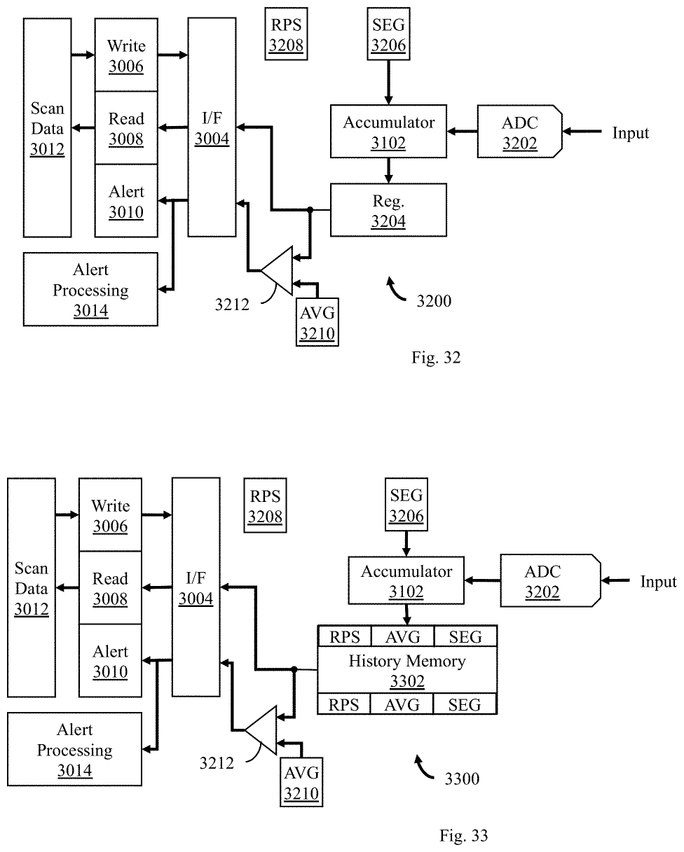

FIG. 32 illustrates, in block diagram form, a hardware trojan instrument facility 3200 adapted to evaluate an RPS according to some embodiments. Hardware trojan instrument facility 3200 may include ADC 3202, an interface facility 3004, and, analogous to the trojan instrument facility 1205 of FIG. 12, may include a register write field 3006, register read field 3008, register alert field 3010, and may also include an interface to the scan chain in the system, here represented by scan data 3012. Additionally, hardware instrument 3100 may include an accumulator 3102, register 3204, segment count register 3206, RPS count register 3208, average register 3210, and comparator 3212. During operations, each sample acquired by the ADC 3202 is provided to the accumulator 3102. The accumulator may accumulate the samples over a selected period of time and may then provide an average of those samples for the selected period of time to register 3204. The selected period of time over which samples are accumulated and averaged may be controlled by segment register 3206. By way of example, if the segment count register is for the first segment of the exemplary RPS, the accumulator may collect and average samples over the first 20 uS of the RPS. Likewise, if the segment count register is for the second segment of the exemplary RPS, the accumulator may collect and average samples of the remaining 144 uS of the RPS. The register 3204 may provide the average of the samples to interface 3004 which provides access to the scan data 3012 by way of read register 3008. During operation, RPS count register may be incremented at the end of each RPS and provided to interface 3004 which provide access to the scan data 3012 by way of read register 3008. In this manner, each average may be associated with a particular segment and a particular RPS. Average register 3210 may be updated periodically with the overall expected average of a particular segment, e.g., a segment average. This update may be provided by accumulating averages at a system level and having the system update the register periodically. To detect anomalous behavior of the RPS, an alert facility comprising comparator 3212 may periodically compare the accumulated average of a particular RPS and segment being presently samples to an expected or learned average of a particular RPS and segment. The expected or learned average is written to average register 3210 for a particular segment, e.g., segment 1 for the pulse portion of the RPS and segment 2 for the low voltage or noise floor section of the RPS. More specifically, during a first segment sample, the average register 3210 may represent the average voltage over the first 20 us of the RPS. Likewise, during a second segment sample, the average register 3210 may represent the average voltage over the remaining 144 us of the RPS. According to one embodiment, comparator 3212 may operate to detect when the segment average is higher than the expected average and provide a logic_0 or logic_1 to interface block 3004 indicating an alert situation, e.g., anomalous behavior has been detected. Similarly, according to a different embodiment, comparator 3212 may operate to detect when the segment average is lower than the expected average stored in average register 3210. According to yet a different embodiment, multiple comparators may be employed to detect upper and lower bounds of an expected average range. Other embodiments are anticipated.

FIG. 33 illustrates, in block diagram form, a hardware trojan instrument facility 3200 adapted to evaluate an RPS according to some embodiments. Hardware trojan instrument facility 3200 may include ADC 3202, an interface facility 3004, and, analogous to the trojan instrument facility 1205 of FIG. 12, may include a register write field 3006, register read field 3008, register alert field 3010, and may also include an interface to the scan chain in the system, here represented by scan data 3012. Additionally, hardware instrument 3100 may include an accumulator 3102, history memory 3302, segment count register 3206, RPS count register 3208, average register 3210, and comparator 3212. According to this embodiment, history memory 3302 may include multiple entries, and each entry may include the particular average of the particular sample period, as well as storing the particular RPS count and segment count, e.g., here illustrated by the RPS, AVG, and SEG fields. During operations, each sample acquired by the ADC 3202 is provided to the accumulator 3102. The accumulator may accumulate the samples over a selected period of time and may then provide an average of those samples for the selected period of time to history memory 3302, along with the RPS count and the segment count. The selected period of time over which samples are accumulated and averaged may be controlled by segment register 3206. By way of example, if the segment count register is for the first segment of the exemplary RPS, the accumulator may collect and average samples over the first 20 uS of the RPS. Likewise, if the segment count register is for the second segment of the exemplary RPS, the accumulator may collect and average samples of the remaining 144 uS of the RPS. The history memory 3302 may provide the average of the samples to interface 3004 which provides access to the scan data 3012 by way of read register 3008. During operation, RPS count register may be incremented at the end of each RPS and provided to interface 3004 which provide access to the scan data 3012 by way fo read register 3008. In this manner, each average may be associated with a particular segment and a particular RPS. Average register 3210 may be updated periodically with the overall expected average of a particular segment. This update may be provided by accumulating averages at a system level and having the system update the register periodically. To detect anomalous behavior of the RPS, comparator 3212 may periodically compare the accumulated average of a particular RPS and segment being presently samples to an expected or learned average of a particular RPS and segment. The expected or learned average is written to average register 3210 for a particular segment, e.g., segment 1 for the pulse portion of the RPS and segment 2 for the low voltage or noise floor section of the RPS. More specifically, during a first segment sample, the average register 3210 may represent the average voltage over the first 20 us of the RPS. Likewise, during a second segment sample, the average register 3210 may represent the average voltage over the remaining 144 us of the RPS. According to one embodiment, comparator 3212 may operate to detect when the segment average is higher than the expected average. Similarly, according to a different embodiment, comparator 3212 may operate to detect when the segment average is lower than the expected average stored in average register 3210. According to yet a different embodiment, multiple comparators may be employed to detect upper and lower bounds of an expected average range. Other embodiments are anticipated.

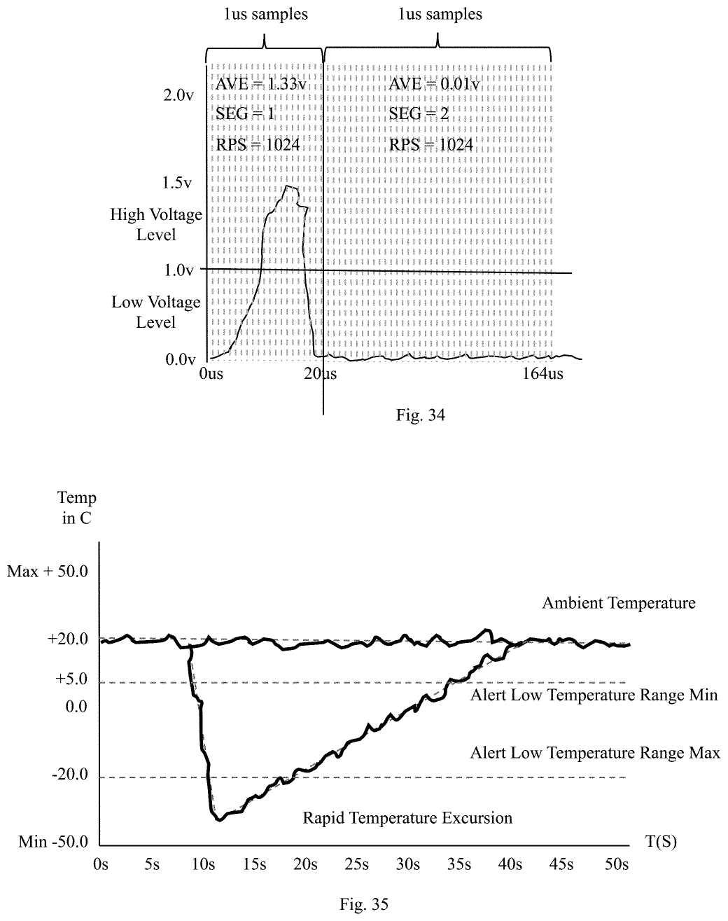

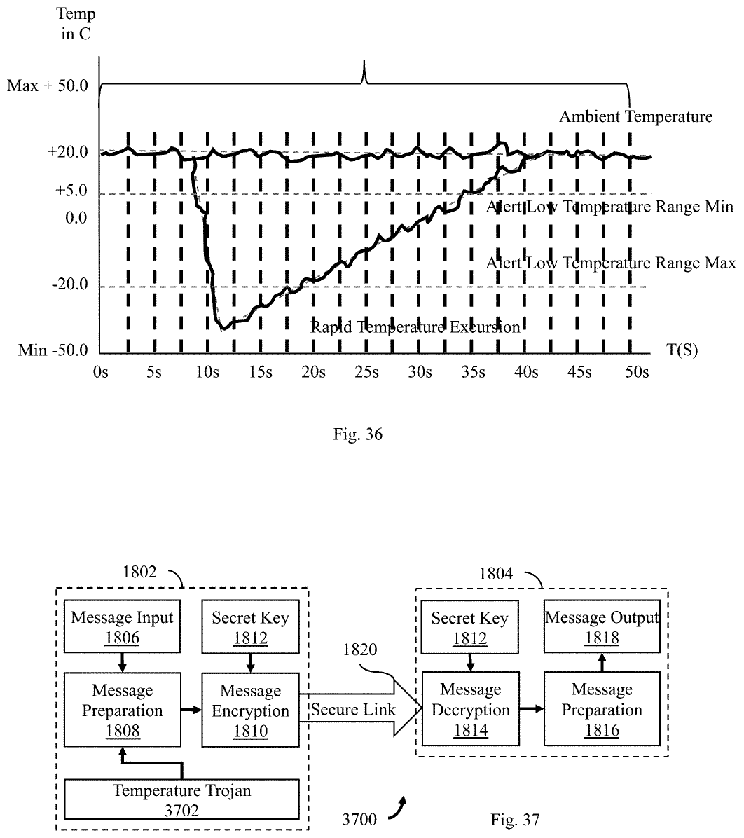

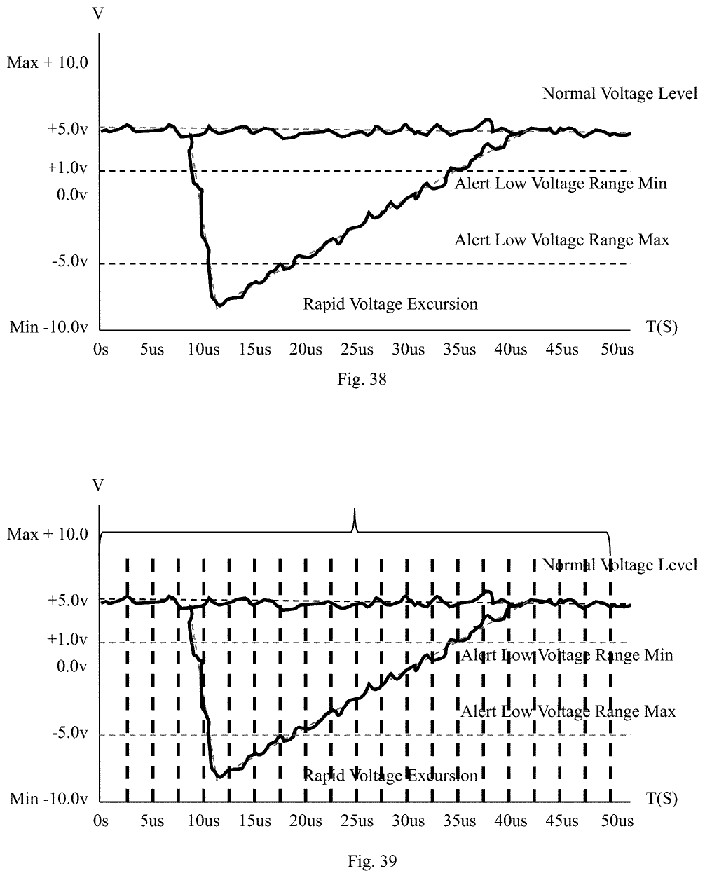

Referring to FIG. 34, according to this embodiment, hardware instrument 3100 processes each sample to immediately evaluate it in the context of the four quadrants to place the sample in one of two variables: (i) part of the noise floor, e.g., below 1.0V and within the time period where no waveform voltage exceeds 1.0V; and (ii) part of the analog pulse and within the time period where the waveform voltage exceeds 1.0V. The samples log their measured voltage and a sample counter logs the number of samples so that a mathematical average can be calculated, e.g., dividing the total accumulated voltage value for the time period by the number of samples that produced that accumulated voltage number to produce and average. Over time, with no waveform manipulation present, the instrument may provide data to a software algorithm, or to a hardware algorithm that may “learn” the average voltage for the two portions of the waveform. When the waveform is manipulated using any of three of the modulations described above, e.g., amplitude, pulse-width, or noise-floor, then the average numbers associated with the two quadrants will not match the numbers associated with normal operation. According to some embodiments, averaging the two portions separately allows detection of the particular case where the pulse voltage levels and the noise-floor voltage levels are each separately manipulated in a way that a single average the whole space could have completely different waveform shapes but arrive at the same numerical average.

According to this embodiment, for the one case of manipulating the length of time of the noise-floor or low-voltage portion of the waveform, simply taking an average may not be enough to detect any manipulation. By way of example, the noise-floor time may be reduced by 10 microseconds. If the voltage level is truly 0.00+/−0.02 v, the average over a 144 samples may not be discernable from an average over 134 samples. The 134 sample period may still produce 0.00+/−0.02 v, which will not identify that 10 microseconds have been removed or added to the period length. Thus, a secondary check is required that accumulates the number of RPS frames required to assemble a chirp. In this embodiment, it requires the accumulation of 182,926 RPS frames to produce one audible chirp in a 30 second period, e.g., 30 seconds/164 micro-seconds. An additional clocking portion of the instrument is required in the audible chirp portion of FIG. 20 that produces a 30 second time window. This clocking portion will produce an exact 30 second time metric. If the proper number of counted pulses is either short of 182,926 or exceeds the 182,926, then a detection of manipulation may be logged. By way of example, if all of the RPS manipulations removed 10 microseconds from the 164 microsecond RPS frame, then the normal 182,926 RPS frames required to make an audible chirp would be 1,829,260 microseconds short at the true 30 second point—there could be 11,154 more pulses in the pulse counter when the count is assessed. Similarly, if every RPS was manipulated to add 10 microseconds, then 1,829,260 microseconds would be added to the total count and the pulse counter would be 11,154 pulses short at the 30 second evaluation point. The only condition that would result in the correct number of pulses when manipulations are applied is if the leaked data contains exactly the same number of 1's and 0's and the manipulation to consider the leaked data as a logic-1 adds, and to consider the leaked data as a logic-0, subtracts the exact same length of time. This is a difficult Trojan to create if the exact nature of the secret key is unknown to the bad actor that places the leaker Trojan into the hardware. If the count at 30 seconds does not match the required count, then a different type of audible sound could be generated, such as an alert sound, that would indicate that a manipulation has been detected.

It should be noted that this technique of averaging segments of the RPS frame is extendable to any manner of different types of RPS's. The RPS frame may be partitioned into several different segments that contain one or more different types of analog waveforms and different thresholds or multiple thresholds may exist for different purposes. The goal is to produce an integration of each identified segment and to convert that integration into a number, for example the average voltage level within the measured segment. FIG. 34 illustrates such a reduction of data from the storage of individual samples to the storage of the calculated variables. Instead of transmitting and exporting the sample value, the sample time, the RPS count and other high-volume sampling data, each RPS can be reduced to a number that represents the segment index, an average voltage number, and the RPS index number.

Another possible non-digital attack component is to use an environmental parameter, e.g., temperature, humidity, air pressure, altitude, sound level, light illumination level, and other such external phenomena as a trigger to activate a Trojan. The Trojan may be analog or digital. By way of example, one embodiment of an environmental attack would be to use a temperature excursion as an attack. FIG. 35 illustrates, in waveform, a simplified diagram that shows the steady state value of temperature of an operating system or device. Illustrated is an exemplary normal operating temperature of the electronics associated with the messaging system of FIG. 18, e.g., 20° C. A change in operating temperature will occur if the unit is moved from a warm area to a cold area such as Antarctica or to a hot area such as a tropical desert like the Sahara. This type of temperature change will be slow and could represent a location-based trigger. By way of example, a Trojan may activate and prevent the unit from working if the temperature is extremely low such as −20 C. However, a more rapid attack may occur with the use of a coolant spray or a heat gun such as a common hair dryer. This type of attack will create a rapid excursion of temperature and then a recovery ramp, as illustrated in FIG. 35. The main difference between this type of effect and the manipulation of a waveform is that there is generally no waveform or signal being propagated anywhere as a functional signal. The ambient temperature of the device and any changes to those temperatures are invisible items to operation unless there are temperature sensors or monitors associated with the device for other purposes such as those used to prevent overheating. Some devices do use embedded temperature sensors, but generally to detect overtemperature conditions that may apply a cooling fan or a reduction in operation activity or clock frequency to remain within a safe operating temperature range.

An embedded temperature sensing instrument may be a reused embedded instrument or a dedicated added instrument and placed within the device. By way of example, as is understood, a temperature diode with a constant current applied may increase or decrease by a linear rate of a deterministic amount over a temperature range, e.g., 1-2 millivolts. According to one embodiment, using such a temperature diode, the voltage may be sampled using an ADC and a digital data value can be created, analogous the earlier embodiment illustrated in FIG. 32. According to a different embodiment, a ring-oscillator may be used. According to this embodiment, the ring-oscillator may oscillate at a particular frequency as a function of the physical architecture (wire length) and parameters of the transistors (switching speed), and, for a specific fixed-voltage, will speed up and slow down as a function of temperature. The switching frequency may be captured in a counter such that as the temperature changes, the count value per time period also changes. In either of these temperature measuring embodiments, there is a digital data value that can be monitored that can be converted to a temperature. FIG. 36 illustrates the simplified waveform diagram with an overlay of temperature sensing samples. These samples may be tracked over time to identify that the temperature has achieved a steady-state, or is moving slowly over time to a new steady-state, or is moving rapidly in an excursion and recovery ramp type of waveform. FIG. 36 also illustrates, in a simplified waveform diagram, the rapid temperature excursion and recovery ramp.

An exemplary attack may include a nefarious individual using an aerosol coolant to spray a unit that include a Trojan circuit. This attack method may then allow a warming period followed by another rapid cooling period, e.g., sprays the unit again with the coolant spray. The two rapid cool downs are recognized by the Trojan circuit and this activates the Trojan payload. By way of example, the Trojan may block the system of FIG. 18 from processing the messages or the Trojan may activate a fault within the data decryptor or data conversion unit such that the message is either not displayed or is displayed as a garbled message. By way of another example, the temperature excursion may activate the secret key data leaker shown in FIG. 24. FIG. 36 illustrates a simplified block diagram of the secure messaging system from FIG. 18 and further shows a denial-of-service Trojan applied when a temperature trigger is asserted. In this exemplary embodiment, the double temperature excursion is recognized by the Trojan circuit as an activation trigger and may prevent the end-of-message packet from being generated and added to the transmitted message. This has an effect on the receiver in that it never receives its end-of-message packet and goes into an open waiting condition. The message is never completed and so the receiver may time-out, but the real impact is that the message is never completely processed and so is never displayed. If the recovery requires the rebooting of the system, then the message is lost.

A very similar attack can be accomplished with a simple analog voltage level, e.g., a power supply voltage applied to a circuit. Analogous to the temperature method described earlier, a constant voltage may be applied to provide power to a circuit. A high intensity switching event within the device may cause a power droop which will then recover and will have a similar waveform diagram to that of the temperature attack, e.g., a power droop excursion and a slow recovery ramp. The source of the droop may be, by way of example, at the power supply itself, if the power supply has adjustments and a nefarious individual operates those adjustments to cause a similar droop.

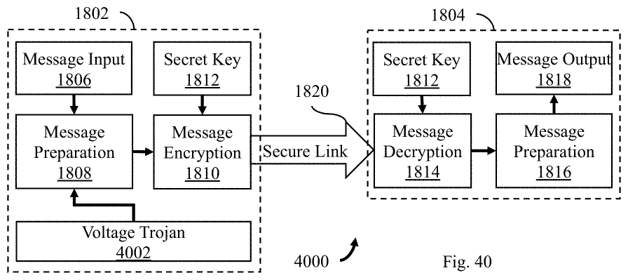

An exemplary attack may include a nefarious individual manipulating the output voltage of the power supply. In this exemplary attack, the voltage droop is recognized by the Trojan circuit and subsequently activates the Trojan payload. As with the previous example, the Trojan can block the ability for FIG. 18 to process messages. FIG. 40 illustrates a simplified block diagram of the secure messaging system from FIG. 18 and further shows a denial-of-service Trojan applied when a voltage trigger is asserted. The voltage excursion is recognized by the Trojan circuit as an activation trigger and prevents the end-of-message packet from being generated and added to the transmitted message. This has an effect on the receiver in that it never receives its end-of-message packet and goes into an open waiting condition. The message is never completed and so the receiver may time-out, but the real impact is that the message is never completely processed and so is never displayed. If the recovery requires the rebooting of the system, then the message is lost.
[End New Text]

Apparatus, methods and systems according to embodiments of the disclosure are described. Although specific embodiments are illustrated and described herein, it will be appreciated by those of ordinary skill in the art that any arrangement which is calculated to achieve the same purposes can be substituted for the specific embodiments shown. This application is intended to cover any adaptations or variations of the embodiments and disclosure. For example, although described in terminology and terms common to the field of art, exemplary embodiments, systems, methods and apparatus described herein, one of ordinary skill in the art will appreciate that implementations can be made for other fields of art, systems, apparatus or methods that provide the required functions. The invention should therefore not be limited by the above described embodiment, method, and examples, but by all embodiments and methods within the scope and spirit of the invention.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future systems, future apparatus, future methods, and different materials.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

Terminology used in the present disclosure is intended to include all environments and alternate technologies that provide the same functionality described herein.

What is claimed is:

1. A hardware trojan instrument facility for monitoring an analog voltage signal for manipulation by a trojan circuit, said hardware trojan instrument facility comprising:
a voltage sampler facility adapted to:
receive said analog voltage signal; and
develop a plurality of digital outputs over a selected period of time, representative of said analog voltage signal;
an accumulator facility adapted to:
receive said plurality of digital outputs; and
develop a first average value of said plurality of digital outputs over said selected period time;
an register facility adapted to:
receive said first average value;
store said first average value; and
develop a register output, said register output comprising said stored first average value; and
an alert facility adapted to:
compare said stored first average value with an expected average value; and
develop an alert indicative of anomalous behavior of said analog voltage signal.

2. The hardware trojan instrument facility of claim 1 further comprising a segment count register, said accumulator being further adapted to receive a segment count value from said segment count register and develop said first average value of said plurality of digital outputs over said selected period of time as a function of said segment count value.

3. The hardware trojan instrument facility of claim 2 further comprising a plurality of scannable access points arranged in series, an alert field adapted to capture said alert indicative of anomalous behavior of said analog voltage signal.

4. A method for monitoring an analog voltage signal for manipulation by a trojan circuit using a hardware trojan instrument facility, said hardware trojan instrument facility comprising:
a voltage sampler facility;
an accumulator facility;
an alert facility
said method comprising the steps of:
developing by a voltage sampler facility a plurality of digital outputs over a selected period of time, said plurality of digital outputs being representative of said analog voltage signal;
developing by said accumulator facility a first average value of said plurality of digital outputs over said selected period of time;
storing an expected average value;
storing said first average value; and
developing by said alert facility an alert indicative of anomalous behavior of said analog voltage signal as a function of comparing said expected average value and said first average value.

5. An electronic system comprising a hardware trojan instrument facility according to claim 1.
